(19) United States
(12) Patent Application Publication
(10) Pub. No.: US 2016/0164781 A1
(43) Pub. Date: Jun. 9, 2016

(54) TRANSMISSION ROUTE DESIGN METHOD, TRANSMISSION ROUTE DESIGN SYSTEM AND TRANSMISSION ROUTE DESIGN APPARATUS

(71) Applicant: FUJITSU LIMITED, Kawasaki-shi (JP)

(72) Inventors: Satoshi Imai, Kawasaki (JP); Yuzo Kusakabe, Fukuoka (JP)

(73) Assignee: FUJITSU LIMITED, Kawasaki (JP)

(21) Appl. No.: 14/943,095

(22) Filed: Nov. 17, 2015

(30) Foreign Application Priority Data
Dec. 9, 2014 (JP) 2014-248963

(51) Int. Cl. H04L 12/721; H04L 12/26

(52) U.S. Cl. CPC H04L 45/70; H04L 43/0882

(57) ABSTRACT

A transmission route design method includes receiving, by a network management apparatus, new demands respectively including a start time and an end time and respectively used for requesting to set a new route; acquiring one or more established routes that are already set and that correspond to a time period between an earliest start time and a latest end time; dividing the time period into slots, based on the start time and the end time; generating intermediate data by calculating a maximum traffic load of each of one or more links included in the one or more established routes for each of the slots; transmitting the generated intermediate data to the transmission route design apparatus; determining, by the transmission route design apparatus, routes to be allocated to the new demands, based on the generated intermediate data; and transmitting information of the determined routes to the network management apparatus.

### CROSS-REFERENCE TO RELATED APPLICATION

This application is based upon and claims the benefit of priority of the prior Japanese Patent Application No. 2014-248963, filed on Dec. 9, 2014, the entire contents of which are incorporated herein by reference.

### FIELD

The embodiments discussed herein are related to a transmission route design method, a transmission route system and a transmission route design apparatus.

### BACKGROUND

It is known that, in order to ensure communication quality of a network, a bandwidth of the network is reserved by specifying a time zone thereof. For example, Japanese Laid-open Patent Publication No. 2001-251354 discloses that, upon receiving a bandwidth reservation request, bandwidth reservation information for each of time zones is referenced, an overlap between an existing bandwidth reservation and a reserved time zone is searched for, and reserved bandwidths are integrated in a case of overlaps, thereby verifying whether or not an integrated value exceeds the bandwidth of a communication processing apparatus. Japanese Laid-open Patent Publication No. 2001-223741 discloses that reservation information of a bandwidth and a time zone of a network is managed using a tree structure, thereby managing bandwidth reservation information.

However, in a case of comparing the integrated value of reserved bandwidths with the bandwidth of the communication processing apparatus, a load of the network turns out to be concentrated in, for example, a link, and in some cases the load is not adequately distributed. In a case where there is, for example, a link in which the load of the network is concentrated, the power consumption of a communication apparatus of the relevant link increases and sometimes rises to a level greater than in a case where the load is leveled for the power consumption of the entire network. Therefore, it becomes difficult to improve the usage efficiency of the network or the efficiency of the power consumption thereof.

### SUMMARY

According to an aspect of the invention, a transmission route design method executed by a transmission route design system including a transmission route design apparatus configured to determine a route within a network and a network management apparatus configured to manage the network, the transmission route design method includes receiving, by the network management apparatus, new demands respectively including a start time and an end time and respectively used for requesting to set a new route; acquiring one or more established routes that are already set within the network and that correspond to a time period between an earliest start time and a latest end time, included in the new demands; dividing the time period into slots, based on the start time and the end time, included in each of the new demands; generating intermediate data by calculating a maximum traffic load of each of one or more links included in the one or more established routes for each of the slots; transmitting the generated intermediate data to the transmission route design apparatus; determining, by the transmission route design apparatus, routes to be allocated to the new demands, based on the generated intermediate data; and transmitting information of the determined routes to the network management apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a transmission route design system of a first example;

FIG. 2 is a diagram illustrating an example of a NW data storage unit;

FIG. 3 is a diagram illustrating an example of an intermediate data storage unit;

FIG. 4 is a diagram illustrating an example of a configuration of a network;

FIG. 5 is a diagram illustrating an example of a relationship between reservations for established paths and new demands;

FIG. 6A, FIG. 6B, FIG. 6C, and FIG. 6D are diagrams each illustrating an example of calculation of a maximum traffic load of each of links in a slot;

FIG. 7A, FIG. 7B, FIG. 7C, and FIG. 7D are diagrams each illustrating an example of a maximum traffic load due to an established path of each of links in each of slots;

FIG. 8A, FIG. 8B, FIG. 8C, and FIG. 8D are diagrams each illustrating an example of a check of a route;

FIG. 9A, FIG. 9B, FIG. 9C, and FIG. 9D are diagrams each illustrating another example of a check of a route;

FIG. 10A, FIG. 10B, and FIG. 10C are diagrams each illustrating an example of calculation of an estimated delay in a route candidate;

FIG. 11 is a flowchart illustrating an example of transmission route design processing of the first example;

FIG. 12 is a block diagram illustrating an example of a configuration of a transmission route design system of a second example;

FIG. 13 is a flowchart illustrating an example of transmission route design processing of the second example;

FIG. 14 is a block diagram illustrating an example of a configuration of a transmission route design system of a third example;

FIG. 15 is a diagram illustrating another example of a relationship between reservations for established paths and new demands;

FIG. 16 is a diagram illustrating examples of variable definitions of each of new demands;

FIG. 17 is a flowchart illustrating an example of transmission route design processing of the third example;

FIG. 18 is a block diagram illustrating an example of a configuration of a transmission route design system of a fourth example;

FIG. 19 is a flowchart illustrating an example of transmission route design processing of the fourth example; and

FIG. 20 is a diagram illustrating an example of a computer that executes a transmission route design program.

### DESCRIPTION OF EMBODIMENTS

Hereinafter, based on drawings, examples of a transmission route design apparatus and a transmission route design method, disclosed in the present application, will be described in detail. A disclosed technology is not limited by the present examples. The following examples may be arbitrarily combined to the extent that they do not contradict each other.

### FIRST EXAMPLE

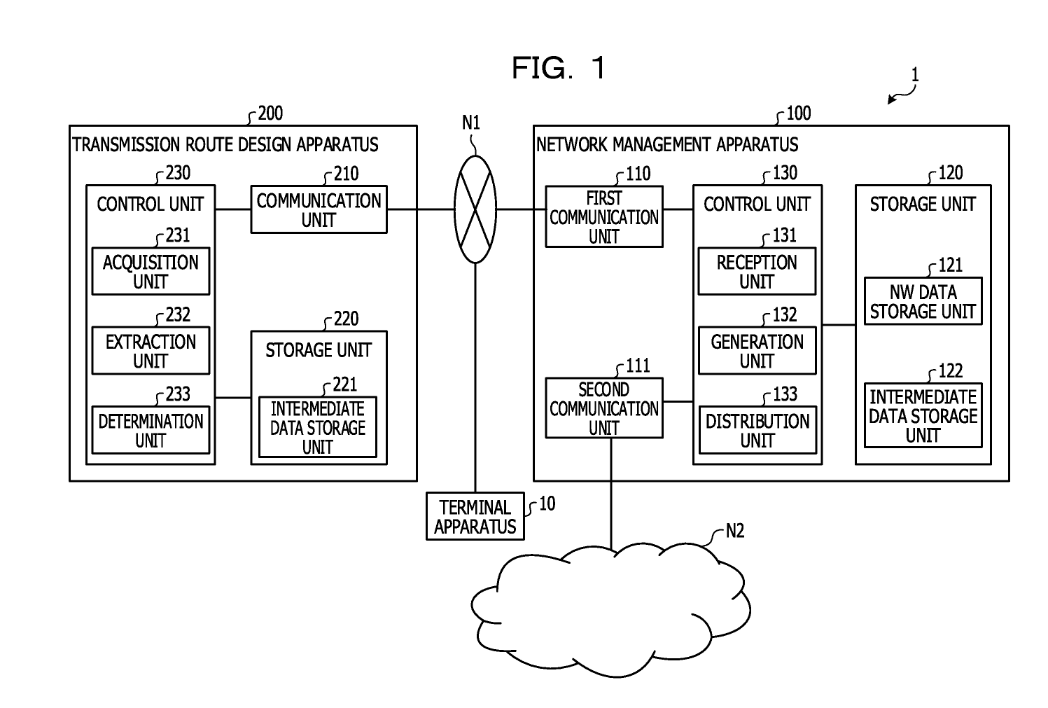

FIG. 1 is a block diagram illustrating an example of a configuration of a transmission route design system of a first example. A transmission route design system 1 illustrated in FIG. 1 includes a terminal apparatus 10, a network management apparatus 100, and a transmission route design apparatus 200. The terminal apparatus 10, the network management apparatus 100, and the transmission route design apparatus 200 are connected so as to be able to intercommunicate with each other via a network N1. As such a network N1, regardless of wired or wireless, arbitrary types of communication network such as a local area network (LAN) and a virtual private network (VPN), which include the Internet, may be adopted. The network management apparatus 100 manages resources of a network N2. Here, the network N2 is, for example, a time reservation type software defined network (SDN).

In the transmission route design system 1 illustrated in FIG. 1, in order to reserve new paths in, for example, the network N2, an administrator causes the terminal apparatus 10 to transmit, to the network management apparatus 100, new demands that request routes of the new paths. Upon receiving the new demands, the network management apparatus 100 divides, into slots, a time period between a start date and time and an end date and time of all the received new demands. In addition, the network management apparatus 100 calculates a maximum traffic load in each of links of a route of an established path for each of the slots. The network management apparatus 100 transmits, to the transmission route design apparatus 200, intermediate data, generated so as to indicate a calculated maximum traffic load of each of links of the network in each of the slots, and the new demands. Upon receiving the intermediate data and the new demands, the transmission route design apparatus 200 determines, based on the received intermediate data and new demands, routes to be allocated to paths of the new demands. The transmission route design apparatus 200 transmits the determined routes of paths to the network management apparatus 100. The network management apparatus 100 sets the routes of paths in the network N2. From this, the transmission route design system 1 determines the routes of the new paths in consideration of the maximum traffic loads of the established paths. Therefore, it is possible to efficiently perform bandwidth allocation on the new paths.

The terminal apparatus 10 is, for example, a computer used by the administrator of the network N2. The terminal apparatus 10 transmits, to the network management apparatus 100, management information of the network N2, such as, for example, the new demands for reserving the new paths. As an example of such a terminal apparatus 10, a portable personal computer may be adopted. Not only a portable terminal such as the above-mentioned personal computer but also a stationary personal computer may be adopted as the terminal apparatus 10. As for the terminal apparatus 10, in addition to the above-mentioned personal computer, a mobile communication terminal or the like, such as, for example, a tablet terminal, a smartphone, a mobile phone, or a personal handyphone system (PHS), may be adopted as the portable terminal.

Next, a configuration of the network management apparatus 100 will be described. As illustrated in FIG. 1, the network management apparatus 100 includes a first communication unit 110, a second communication unit 111, a storage unit 120, and a control unit 130. In addition to the functional units illustrated in FIG. 1, the network management apparatus 100 may include various kinds of functional units, included in a known computer, for example, functional units such as various kinds of input devices and a sound-output device.

The first communication unit 110 is realized by, for example, a network interface card (NIC) or the like. The first communication unit 110 is a communication interface that is wirelessly or wiredly connected to the terminal apparatus 10 and the transmission route design apparatus 200 via the network N1 and that manages communication of information with the terminal apparatus 10 and the transmission route design apparatus 200. The first communication unit 110 receives a new demand from the terminal apparatus 10 and receives route information of a path from the transmission route design apparatus 200. The first communication unit 110 outputs, to the control unit 130, the received new demand and the received route information of a path. The first communication unit 110 transmits, to the transmission route design apparatus 200, a new demand, intermediate data, and network information, input by the control unit 130. An application programming interface (API) that utilizes a protocol such as, for example, representational state transfer (REST) may be used for communication between the network management apparatus 100 and the transmission route design apparatus 200.

The second communication unit 111 is realized by, for example, an NIC or the like. The second communication unit 111 is a communication interface that is wirelessly or wiredly connected to individual nodes of the network N2, not illustrated, and that manages communication of information with the individual nodes of the network N2. The second communication unit 111 receives information of the individual nodes or the like and outputs the received information of the individual nodes to the control unit 130. The second communication unit 111 transmits route information of a path, input by the control unit 130, to the individual nodes of the network N2.

The storage unit 120 is realized by, for example, a semiconductor memory element such as a random access memory (RAM) or a flash memory or a storage apparatus such as a hard disk or an optical disk. The storage unit 120 includes a network (NW) data storage unit 121 and an intermediate data storage unit 122. The storage unit 120 stores therein information used for processing in the control unit 130.

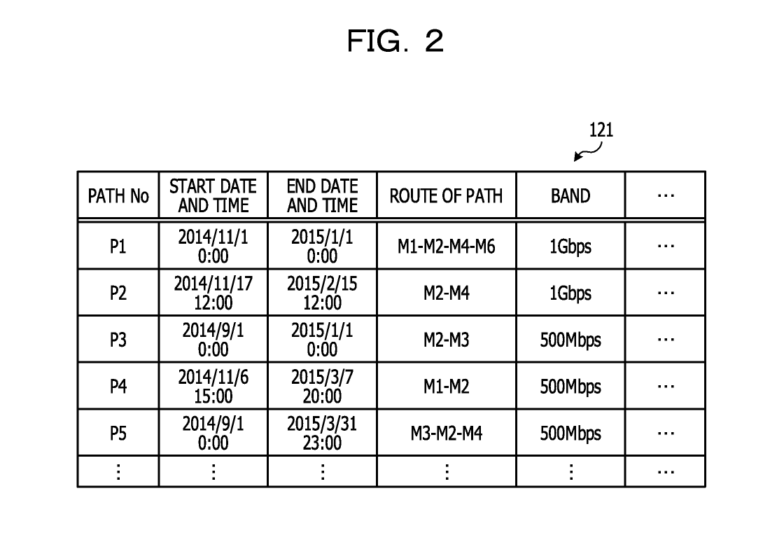

The NW data storage unit 121 stores therein usage states of the resources of the network N2. FIG. 2 is a diagram illustrating an example of a NW data storage unit. As illustrated in FIG. 2, the NW data storage unit 121 includes items such as a “path No”, a “start date and time”, an “end date and time”, a “route of a path”, and a “bandwidth”. The NW data storage unit 121 stores therein one record for, for example, one path.

The “path No” identifies a path already set, in other words, already reserved in the network N2. The “start date and time” indicates the start date and time of the relevant path. The “end date and time” indicates the end date and time of the relevant path. The “route of a path” indicates, for example, a node through which the relevant path in the network N2 is routed. The “bandwidth” indicates a bandwidth requested by the relevant path. In an example of the first row in FIG. 2, a path P1 indicates that a bandwidth of 1 Gbps is already set in a route routed through nodes M1, M2, M4, and M6 between 00:00 am on Nov. 1, 2014 and 00:00 am on Jan. 1, 2015.

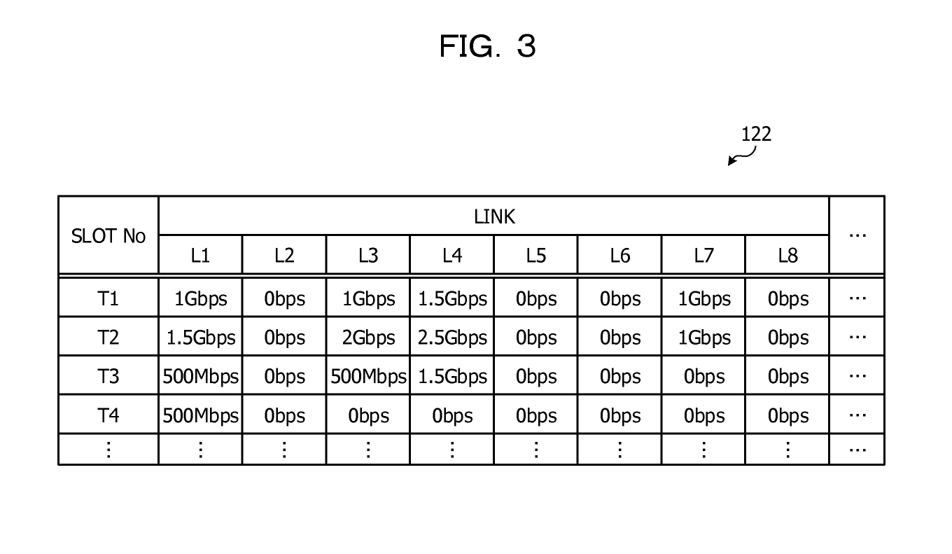

Returning to the description of FIG. 1, the intermediate data storage unit 122 stores therein intermediate data indicating a maximum traffic load in each of links in each of slots. Here, the slots indicate individual time periods obtained by dividing a time period between a start date and time and an end date and time of all new demands while using a start date and time or an end date and time of each of the new demands as a separator. FIG. 3 is a diagram illustrating an example of an intermediate data storage unit. As illustrated in FIG. 3, the intermediate data storage unit 122 includes items such as a “slot No” and a “link”. The intermediate data storage unit 122 stores therein one record for, for example, one slot.

The “slot No” identifies a slot. The “link” indicates a bandwidth of each of links, used by an established path, in each of slots in each of time periods. In an example of the first row in FIG. 3, in a slot T1, 1 Gbps of a link L1, 1 Gbps of a link L3, 1.5 Gbps of a link L4, 1 Gbps of a link L7, and 0 bps of links L2, L5, L6, and L8 are used by established paths.

Returning to the description of FIG. 1, by using a RAM as a working area, for example, a central processing unit (CPU), a micro processing unit (MPU), or the like executes a program stored in an internal storage apparatus, thereby realizing the control unit 130. The control unit 130 may be realized by an integrated circuit such as, for example, an application specific integrated circuit (ASIC) or a field programmable gate array (FPGA). The control unit 130 includes a reception unit 131, a generation unit 132, and a distribution unit 133 and realizes or performs a function or an action of information processing described later. The internal configuration of the control unit 130 is not limited to the configuration illustrated in FIG. 1, and another configuration may be adopted if the other configuration performs the information processing described later.

The reception unit 131 receives new demands from the terminal apparatus 10 via the network N1 and the first communication unit 110. Here, the new demands each include pieces of information such as, for example, information of start and end nodes, start and end dates and times, and a requested bandwidth of a path. The reception unit 131 outputs the received new demands to the generation unit 132.

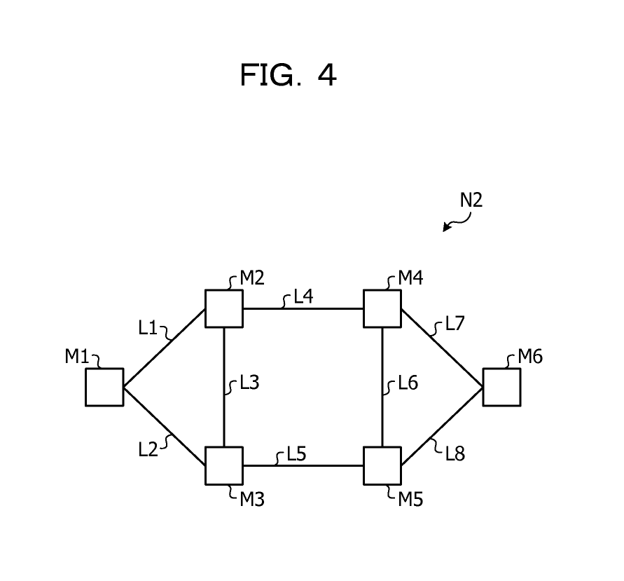

If the new demands are input by the reception unit 131, the generation unit 132 references the NW data storage unit 121, thereby generating intermediate data. The generation unit 132 acquires, from the NW data storage unit 121, established paths corresponding to a time period RT1 between a start date and time and an end date and time of all the new demands. In other words, the generation unit 132 acquires, from the NW data storage unit 121, established paths corresponding to the leading and trailing dates and times of all the new demands. Here, an example of a configuration of the network N2 in which established paths are set is illustrated in FIG. 4. FIG. 4 is a diagram illustrating an example of the configuration of the network N2. As illustrated in FIG. 4, the network N2 has a configuration in which the nodes M1 to M6 are connected by the links L1 to L8.

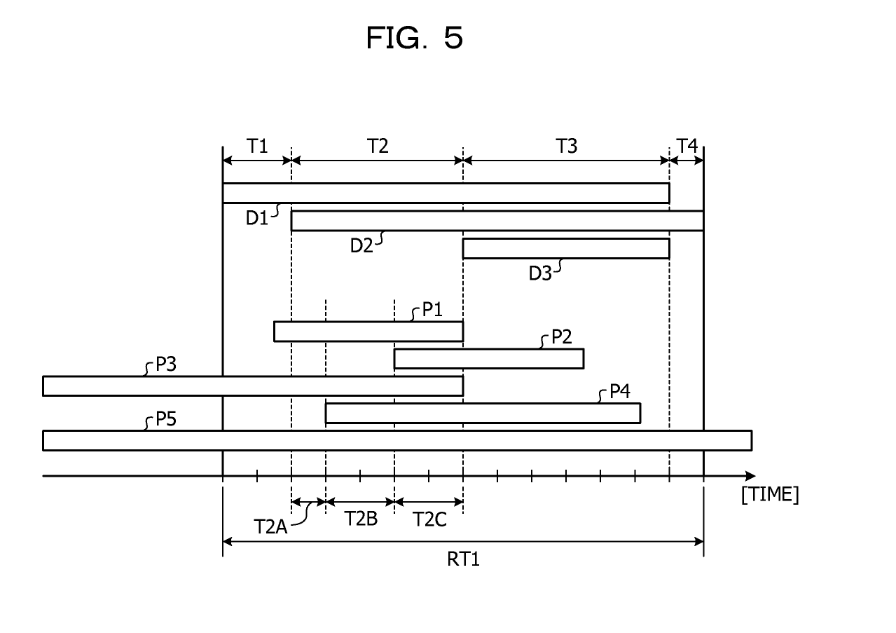

FIG. 5 is a diagram illustrating an example of a relationship between reservations for established paths and new demands. As illustrated in FIG. 5, established paths P1 to P5 are set in the network N2. Here, it is assumed that the established paths P3 and P5 are already used and the established paths P1, P2, and P4 are already reserved paths that are not used. At this time, if new demands D1 to D3 are input, the generation unit 132 divides the time period RT1 between a start date and time of the new demand D1 and an end date and time of the new demand D2 into time periods, separated by a start date and time or an end date and time of each of the new demands D1 to D3, in other words, slots. In other words, the generation unit 132 divides the time period RT1, separated by the leading and trailing dates and times of all the new demands, into the slots T1 to T4. In other words, the generation unit 132 is a setting unit that sets slots. Here, the slot T1 is a time period separated by the start date and time of the new demand D1 and a start date and time of the new demand D2. The slot T2 is a time period separated by the start date and time of the new demand D2 and a start date and time of the new demand D3. The slot T3 is a time period separated by a start date and time of the new demand D3 and end dates and times of the new demands D1 and D3. The slot T4 is a time period separated by the end dates and times of the new demands D1 and D3 and the end date and time of the new demand D2.

Next, the generation unit 132 calculates a maximum traffic load in each of links of routes of established paths for each of the divided slots. In other words, the generation unit 132 is a calculation unit that calculates maximum traffic load of established paths for each of slots. Here, as an example, calculation of a maximum traffic load of each of links in the slot T2 will be described. The generation unit 132 further divides the slot T2 at time points when the bandwidths of the established paths change. In the example of FIG. 5, the generation unit 132 divides the slot T2 into a slot T2A, a slot T2B, and a slot T2C. The slot T2A is a time period between a start date and time of the slot T2 and a start date and time of the established path P4. The slot T2B is a time period between the start date and time of the established path P4 and a start date and time of the established path P2. The slot T2C is a time period between the start date and time of the established path P2 and an end date and time of the slot T2.

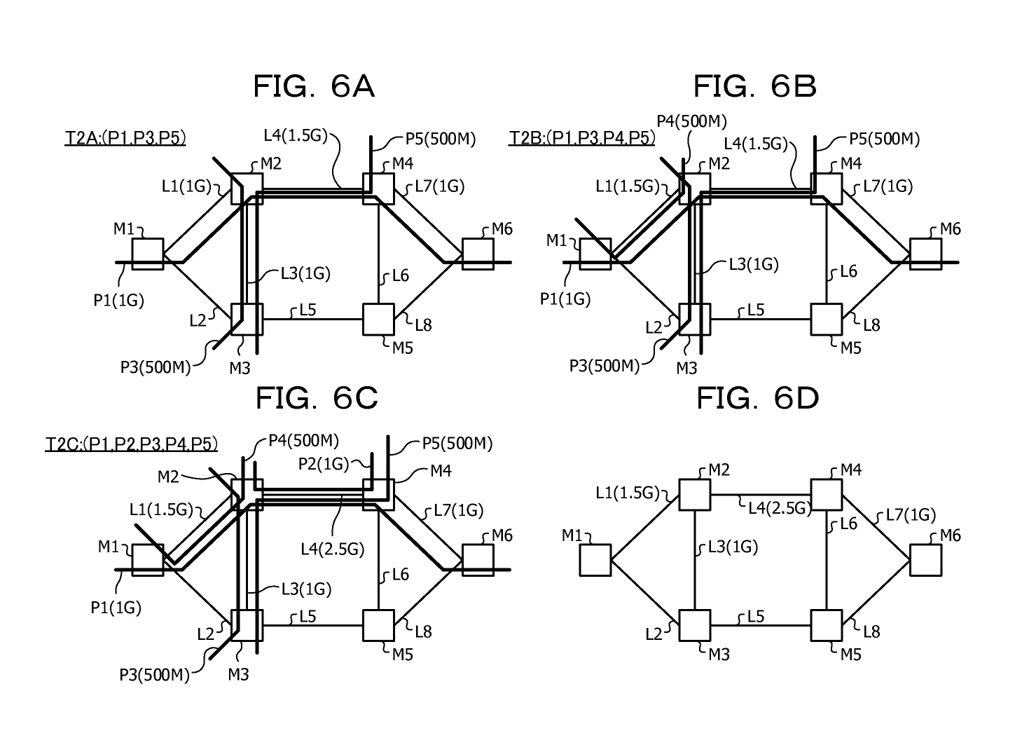

For each of the divided slots T2A to T2C, the generation unit 132 extracts a traffic load, in other words, a used bandwidth of each of links. FIG. 6A, FIG. 6B, FIG. 6C, and FIG. 6D are diagrams each illustrating an example of calculation of a maximum traffic load of each of links in the slot T2. FIG. 6A illustrates traffic loads of established paths in the slot T2A. As illustrated in FIG. 6A, in the slot T2A, the established path P1 is routed through the links L1, L4, and L7, the established path P3 is routed through the link L3, and the established path P5 is routed through the links L3 and L4. As for used bandwidths of the individual established paths, it is assumed that the used bandwidth of the established path P1 is 1 Gbps, the used bandwidth of the established path P3 is 500 Mbps, and the used bandwidth of the established path P5 is 500 Mbps. As for traffic loads of the individual links at this time, the traffic load of the link L1 is 1 Gbps, the traffic load of the link L3 is 1 Gbps, the traffic load of the link L4 is 1.5 Gbps, and the traffic load of the link L7 is 1 Gbps. The traffic loads of the links L2, L5, L6, and L8 through which no established path is routed is 0 bps.

FIG. 6B illustrates traffic loads of established paths in the slot T2B. As illustrated in FIG. 6B, in the slot T2B, the established path P1 is routed through the links L1, L4, and L7, the established path P3 is routed through the link L3, the established path P4 is routed through the link L1, and the established path P5 is routed through the links L3 and L4. Here, it is assumed that the used bandwidth of the established path P4 is 500 Mbps. At this time, as for traffic loads of the individual links, the traffic load of the link L1 increases to 1.5 Gbps compared with the slot T2A, and the traffic loads of the other links are identical to those in the slot T2A.

FIG. 6C illustrates traffic loads of established paths in the slot T2C. As illustrated in FIG. 6C, in the slot T2C, the established path P1 is routed through the links L1, L4, and L7, the established path P2 is routed through the link L4, the established path P3 is routed through the link L3, the established path P4 is routed through the link L1, and the established path P5 is routed through the links L3 and L4. Here, it is assumed that the used bandwidth of the established path P2 is 1 Gbps. At this time, as for traffic loads of the individual links, the traffic load of the link L4 increases to 2.5 Gbps compared with the slot T2B, and the traffic loads of the other links are identical to those in the slot T2B.

FIG. 6D illustrates a maximum traffic load of each of links of the established paths in the slots T2A to T2C. For each of the links, the generation unit 132 defines a maximum value of a used bandwidth in the slot T2A to T2C, as a maximum traffic load of the relevant link in the slot T2. In the example of FIG. 6D, as for the used bandwidth of the link L1, 1.5 Gbps of each of the slots T2B and T2C is a maximum value. Therefore, it is assumed that a maximum traffic load of the link L1 in the slot T2 is 1.5 Gbps. As for each of the link L2 to L8, in the same way, the generation unit 132 calculates a maximum traffic load in the slot T2. As for maximum traffic loads of the links L2 to L8 in the slot T2, a maximum traffic load of the link L3 is 1 Gbps, a maximum traffic load of the link L4 is 2.5 Gbps, a maximum traffic load of the link L7 is 1 Gbps, and maximum traffic loads of the links L2, L5, L6, and L8 are 0 bps.

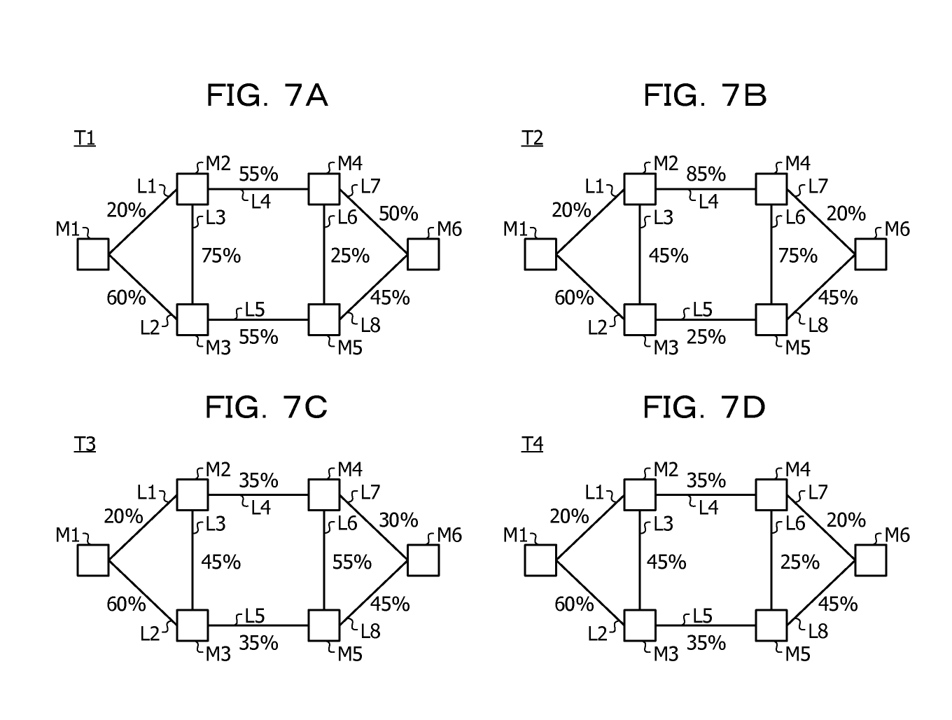

For each of the slots T1, T3, and T4, the generation unit 132 calculates a maximum traffic load of each of the links. FIG. 7A, FIG. 7B, FIG. 7C, and FIG. 7D are diagrams each illustrating an example of a maximum traffic load due to an established path of each of links in each of slots. FIG. 7A illustrates an example of a maximum traffic load due to an established path of each of the links in the slot T1. In each of FIGS. 7A to 7D, a usage rate of a bandwidth of each of the links is illustrated. FIG. 7B illustrates an example of a maximum traffic load due to an established path of each of the links in the slot T2. FIG. 7C illustrates an example of a maximum traffic load due to an established path of each of the links in the slot T3. FIG. 7D illustrates an example of a maximum traffic load due to an established path of each of the links in the slot T4.

Upon calculating a maximum traffic load of each of the links in each of the slots T1 to T4, the generation unit 132 stores, as intermediate data, a calculation result in the intermediate data storage unit 122. The generation unit 132 references the NW data storage unit 121, thereby generating network information indicating a network topology and a bandwidth of each of the links. The generation unit 132 transmits the new demands, the intermediate data, and the network information to the transmission route design apparatus 200 via the first communication unit 110 and the network N1.

Returning to the description of FIG. 1, the distribution unit 133 receives route information of paths from the transmission route design apparatus 200 via the network N1 and the first communication unit 110. Based on the received route information of paths, the distribution unit 133 updates the NW data storage unit 121. The distribution unit 133 transmits the received route information of paths to the individual nodes of the network N2 via the second communication unit 111, thereby distributing the route information of paths to the network N2.

Next, a configuration of the transmission route design apparatus 200 will be described. As illustrated in FIG. 1, the transmission route design apparatus 200 includes a communication unit 210, a storage unit 220, and a control unit 230. In addition to the functional units illustrated in FIG. 1, the transmission route design apparatus 200 may include various kinds of functional units, included in a known computer, for example, functional units such as various kinds of input devices and a sound-output device.

The communication unit 210 is realized by, for example, an NIC or the like. The communication unit 210 is a communication interface that is wirelessly or wiredly connected to the terminal apparatus 10 and the network management apparatus 100 via the network N1 and that manages communication of information with the terminal apparatus 10 and the network management apparatus 100. The communication unit 210 receives a new demand, intermediate data, and network information from the network management apparatus 100. The communication unit 210 outputs, to the control unit 230, the new demand, the intermediate data, and the network information, which are received. The communication unit 210 transmits the route information of paths, input by the control unit 230, to the network management apparatus 100.

The storage unit 220 is realized by, for example, a semiconductor memory element such as a RAM or a flash memory or a storage apparatus such as a hard disk or an optical disk. The storage unit 220 includes an intermediate data storage unit 221. The storage unit 220 stores therein information used for processing in the control unit 230.

The intermediate data storage unit 221 stores therein the intermediate data received from the network management apparatus 100. Since the configuration of the intermediate data storage unit 221 is the same as that of the intermediate data storage unit 122 in the network management apparatus 100, the description thereof will be omitted.

By using a RAM as a working area, for example, a CPU, an MPU, or the like executes a program stored in an internal storage apparatus, thereby realizing the control unit 230. The control unit 230 may be realized by an integrated circuit such as, for example, an ASIC or an FPGA. The control unit 230 includes an acquisition unit 231, an extraction unit 232, and a determination unit 233 and realizes or performs a function or an action of information processing described later. The internal configuration of the control unit 230 is not limited to the configuration illustrated in FIG. 1, and another configuration may be adopted if the other configuration performs information processing described later.

The acquisition unit 231 acquires a new demand, intermediate data, and network information from the network management apparatus 100 via the network N1 and the communication unit 210. The acquisition unit 231 stores the acquired intermediate data in the intermediate data storage unit 221. The acquisition unit 231 outputs the acquired new demand and the acquired network information to the extraction unit 232.

If the new demand and the network information are input by the acquisition unit 231, the extraction unit 232 extracts, based on the network information, a route candidate for the new demand. In a case where there are, for example, new demands, the extraction unit 232 extracts route candidates for the individual new demands and furthermore extracts combination patterns of the extracted route candidates. The extraction unit 232 outputs the combination patterns of the extracted route candidates to the determination unit 233. Upon being instructed by the determination unit 233 to extract again route candidates for the new demands, the extraction unit 232 extracts combination patterns of route candidates by changing, for example, extraction conditions and outputs the combination patterns of route candidates to the determination unit 233.

If the combination patterns of route candidates are input by the extraction unit 232, the determination unit 233 references the intermediate data storage unit 221 and checks, based on each of the route candidates and the intermediate data, the presence or absence of an excess of a bandwidth of each of the links for each of the combination patterns. In other words, for each of links in the network N2, the determination unit 233 determines whether or not there is a route candidate without an excess of a bandwidth for each of the combination patterns.

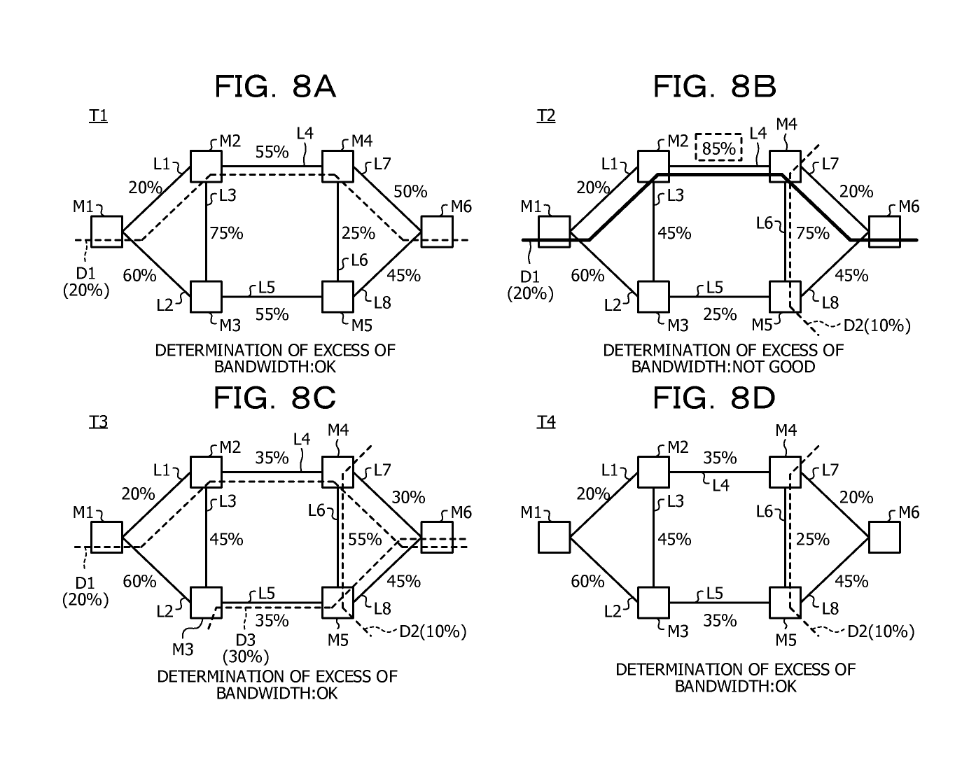

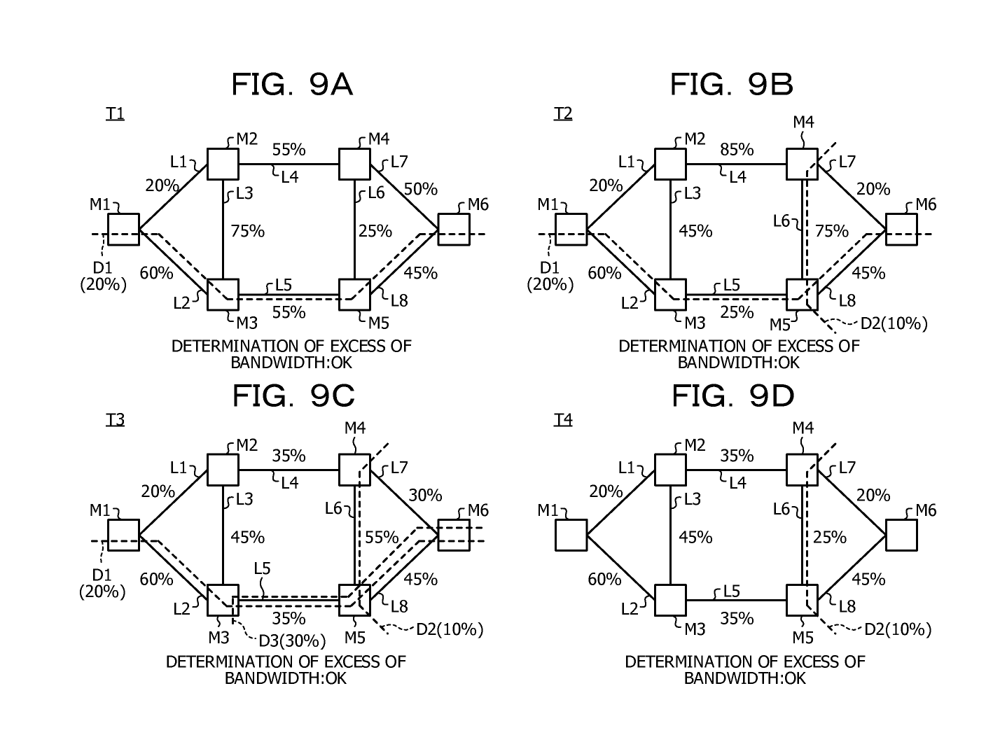

Here, using FIG. 8A, FIG. 8B, FIG. 8C, FIG. 8D, FIG. 9A, FIG. 9B, FIG. 9C, and FIG. 9D, a check of the presence or absence of an excess of a bandwidth of each of links in route candidates will be described. FIG. 8A, FIG. 8B, FIG. 8C, and FIG. 8D are diagrams each illustrating an example of a check of a route. FIG. 9A, FIG. 9B, FIG. 9C, and FIG. 9D are diagrams each illustrating another example of a check of a route. Here, in the following description, the used bandwidth of each of the links and a requested bandwidth requested by a new demand are expressed in percentage. The used bandwidth and the requested bandwidth may be expressed as a currently used or already reserved traffic load (bandwidth) of the corresponding link and a traffic load requested by the corresponding new demand, respectively. In the following description, it is assumed that the traffic load of the new demand D1 is 20%, the traffic load of the new demand D2 is 10%, the traffic load of the new demand D3 is 30%, and a traffic load due to an established path of each of links varies depending on the slots T1 to T4. Furthermore, FIG. 8A, FIG. 8B, FIG. 8C, FIG. 8D, FIG. 9A, FIG. 9B, FIG. 9C, and FIG. 9D illustrate examples in which combination patterns of route candidates are different. Specifically, routes of a path of the new demand D1 in FIG. 8A, FIG. 8B, FIG. 8C, and FIG. 8D are different from routes of the path of the new demand D1 in FIG. 9A, FIG. 9B, FIG. 9C, and FIG. 9D.

FIG. 8A illustrates an example of determination of an excess of a bandwidth in the slot T1. The slot T1 corresponds to a pattern in which the path of the new demand D1 passes through a route of the links L1, L4, and L7. As for traffic loads due to established paths of individual links in the slot T1, it is assumed that the traffic load of the link L1 is 20%, the traffic load of the link L2 is 60%, the traffic load of the link L3 is 75%, the traffic load of the link L4 is 55%, the traffic load of the link L5 is 55%, the traffic load of the link L6 is 25%, the traffic load of the link L7 is 50%, and the traffic load of the link L8 is 45%.

As for the traffic loads of the individual links in a case of the relevant pattern, the traffic load of the link L1 is 20+20=40%, the traffic load of the link L4 is 55+20=75%, and the traffic load of the link L7 is 50+20=70%. While remaining traffic loads due to established paths, the traffic loads of the other links do not change due to the new demand D1. Accordingly, in the slot T1, there is no link in which an excess of a bandwidth occurs. Therefore, the determination of an excess of a bandwidth becomes OK.

FIG. 8B illustrates an example of determination of an excess of a bandwidth in the slot T2. The slot T2 corresponds to a pattern in which the path of the new demand D1 passes through a route of the links L1, L4, and L7 and the path of the new demand D2 passes through a route of the link L6. As for traffic loads due to established paths of individual links in the slot T2, it is assumed that the traffic load of the link L1 is 20%, the traffic load of the link L2 is 60%, the traffic load of the link L3 is 45%, the traffic load of the link L4 is 85%, the traffic load of the link L5 is 25%, the traffic load of the link L6 is 75%, the traffic load of the link L7 is 20%, and the traffic load of the link L8 is 45%.

As for the traffic loads of the individual links in a case of the relevant pattern, the traffic load of the link L1 is 20+20=40%, the traffic load of the link L4 is 85+20=105%, the traffic load of the link L6 is 75+10=85%, and the traffic load of the link L7 is 20+20=40%. While remaining traffic loads due to established paths, the traffic loads of the other links do not change due to the new demands D1 and D2. At this time, in the slot T2, the link L4 becomes 105%. Therefore, the determination of an excess of a bandwidth becomes NG.

FIG. 8C illustrates an example of determination of an excess of a bandwidth in the slot T3. The slot T3 corresponds to a pattern in which the path of the new demand D1 passes through a route of the links L1, L4, and L7, the path of the new demand D2 passes through a route of the link L6, and the path of the new demand D3 passes through a route of the links L5 and L8. As for traffic loads due to established paths of individual links in the slot T3, it is assumed that the traffic load of the link L1 is 20%, the traffic load of the link L2 is 60%, the traffic load of the link L3 is 45%, the traffic load of the link L4 is 35%, the traffic load of the link L5 is 35%, the traffic load of the link L6 is 55%, the traffic load of the link L7 is 30%, and the traffic load of the link L8 is 45%.

As for the traffic loads of the individual links in a case of the relevant pattern, the traffic load of the link L1 is 20+20=40%, the traffic load of the link L4 is 35+20=55%, the traffic load of the link L5 is 35+30=65%, the traffic load of the link L6 is 55+10=65%, the traffic load of the link L7 is 30+20=50%, and the traffic load of the link L8 is 45+30=75%. While remaining traffic loads due to established paths, the traffic loads of the other links do not change due to the new demands D1 to D3. At this time, in the slot T3, there is no link in which an excess of a bandwidth occurs. Therefore, the determination of an excess of a bandwidth becomes OK.

FIG. 8D illustrates an example of determination of an excess of a bandwidth in the slot T4. The slot T4 corresponds to a pattern in which the path of the new demand D2 passes through a route of the link L6. As for traffic loads due to established paths of individual links in the slot T4, it is assumed that the traffic load of the link L1 is 20%, the traffic load of the link L2 is 60%, the traffic load of the link L3 is 45%, the traffic load of the link L4 is 35%, the traffic load of the link L5 is 35%, the traffic load of the link L6 is 25%, the traffic load of the link L7 is 20%, and the traffic load of the link L8 is 45%.

As for the traffic loads of the individual links in a case of the relevant pattern, the traffic load of the link L6 is 25+10=35%. While remaining traffic loads due to established paths, the traffic loads of the other links do not change due to the new demand D2. At this time, in the slot T4, there is no link in which an excess of a bandwidth occurs. Therefore, the determination of an excess of a bandwidth becomes OK. In this way, in the combination patterns of route candidates in FIG. 8A, FIG. 8B, FIG. 8C, and FIG. 8D, there is a slot in which the determination of an excess of a bandwidth becomes NG. Therefore, in the combination patterns of the relevant route candidates, a check result becomes NG (not good).

Next, a check of the combination patterns of route candidates in FIG. 9A, FIG. 9B, FIG. 9C, and FIG. 9D will be described. FIG. 9A illustrates an example of determination of an excess of a bandwidth in the slot T1. The slot T1 corresponds to a pattern in which the path of the new demand D1 passes through a route of the links L2, L5, and L8. As for traffic loads due to established paths of individual links in the slot T1, it is assumed that the traffic load of the link L1 is 20%, the traffic load of the link L2 is 60%, the traffic load of the link L3 is 75%, the traffic load of the link L4 is 55%, the traffic load of the link L5 is 55%, the traffic load of the link L6 is 25%, the traffic load of the link L7 is 50%, and the traffic load of the link L8 is 45%.

As for the traffic loads of the individual links in a case of the relevant pattern, the traffic load of the link L2 is 60+20=80%, the traffic load of the link L5 is 55+20=75%, and the traffic load of the link L8 is 45+20=65%. While remaining traffic loads due to established paths, the traffic loads of the other links do not change due to the new demand D1. Accordingly, in the slot T1, there is no link in which an excess of a bandwidth occurs. Therefore, the determination of an excess of a bandwidth becomes OK.

FIG. 9B illustrates an example of determination of an excess of a bandwidth in the slot T2. The slot T2 corresponds to a pattern in which the path of the new demand D1 passes through a route of the links L2, L5, and L8 and the path of the new demand D2 passes through a route of the link L6. As for traffic loads due to established paths of individual links in the slot T2, it is assumed that the traffic load of the link L1 is 20%, the traffic load of the link L2 is 60%, the traffic load of the link L3 is 45%, the traffic load of the link L4 is 85%, the traffic load of the link L5 is 25%, the traffic load of the link L6 is 75%, the traffic load of the link L7 is 20%, and the traffic load of the link L8 is 45%.

As for the traffic loads of the individual links in a case of the relevant pattern, the traffic load of the link L2 is 60+20=80%, the traffic load of the link L5 is 25+20=45%, the traffic load of the link L6 is 75+10=85%, and the traffic load of the link L8 is 45+20=65%. While remaining traffic loads due to established paths, the traffic loads of the other links do not change due to the new demands D1 and D2. At this time, in the slot T2, there is no link in which an excess of a bandwidth occurs. Therefore, the determination of an excess of a bandwidth becomes OK.

FIG. 9C illustrates an example of determination of an excess of a bandwidth in the slot T3. The slot T3 corresponds to a pattern in which the path of the new demand D1 passes through a route of the links L2, L5, and L8, the path of the new demand D2 passes through a route of the link L6, and the path of the new demand D3 passes through a route of the links L5 and L8. As for traffic loads due to established paths of individual links in the slot T3, it is assumed that the traffic load of the link L1 is 20%, the traffic load of the link L2 is 60%, the traffic load of the link L3 is 45%, the traffic load of the link L4 is 35%, the traffic load of the link L5 is 35%, the traffic load of the link L6 is 55%, the traffic load of the link L7 is 30%, and the traffic load of the link L8 is 45%.

As for the traffic loads of the individual links in a case of the relevant pattern, the traffic load of the link L2 is 60+20=80%, the traffic load of the link L5 is 35+20+30=85%, the traffic load of the link L6 is 55+10=65%, and the traffic load of the link L8 is 45+20+30=95%. While remaining traffic loads due to established paths, the traffic loads of the other links do not change due to the new demands D1 to D3. At this time, in the slot T3, there is no link in which an excess of a bandwidth occurs. Therefore, the determination of an excess of a bandwidth becomes OK.

FIG. 9D illustrates an example of determination of an excess of a bandwidth in the slot T4. The slot T4 corresponds to a pattern in which the path of the new demand D2 passes through a route of the link L6. As for traffic loads due to established paths of individual links in the slot T4, it is assumed that the traffic load of the link L1 is 20%, the traffic load of the link L2 is 60%, the traffic load of the link L3 is 45%, the traffic load of the link L4 is 35%, the traffic load of the link L5 is 35%, the traffic load of the link L6 is 25%, the traffic load of the link L7 is 20%, and the traffic load of the link L8 is 45%.

As for the traffic loads of the individual links in a case of the relevant pattern, the traffic load of the link L6 is 25+10=35%. While remaining traffic loads due to established paths, the traffic loads of the other links do not change due to the new demand D2. At this time, in the slot T4, there is no link in which an excess of a bandwidth occurs. Therefore, the determination of an excess of a bandwidth becomes OK. In this way, in the combination patterns of route candidates in FIG. 9A, FIG. 9B, FIG. 9C, and FIG. 9D, all the determinations of an excess of a bandwidth are OK. Therefore, in the combination patterns of the relevant route candidates, a check result becomes OK.

Returning to the description of FIG. 1, in a case where there is no route candidate without an excess of a bandwidth, the determination unit 233 instructs the extraction unit 232 to change, for example, extraction conditions of route candidates for the new demands and to perform extraction again. In a case where there is a route candidate without an excess of a bandwidth, the determination unit 233 determines the route of a path, which is to be distributed to the network N2, from among route candidates without an excess of a bandwidth. The determination unit 233 transmits, as the route information of a path, the determined route of a path to the network management apparatus 100 via the communication unit 210 and the network N1.

Here, determination of a route of a path in a case where there are route candidates without an excess of a bandwidth will be described. In a case where there are route candidates without an excess of a bandwidth, the determination unit 233 determines, as the route of a path, which is to be distributed to the network N2, the best possible combination pattern of route candidates, which satisfies, for example, a load distribution policy, a power-saving policy, and a minimum delay policy. The load distribution policy selects a combination of route candidates in which an evaluation value of a maximum traffic load in the time period of the new demands D1 to D3 in the network N2 is minimized. The power-saving policy selects a combination of route candidates in which an evaluation value of total power consumption in the time period of the new demands D1 to D3 in the network N2 is minimized. The minimum delay policy selects a combination of route candidates in which estimated delays for the new demands D1 to D3 satisfy delay conditions and in which an evaluation value is minimized, the relevant evaluation value being defined as a maximum value of ratios (estimate values/condition values) between the delay conditions for the respective new demands and estimated values therefor.

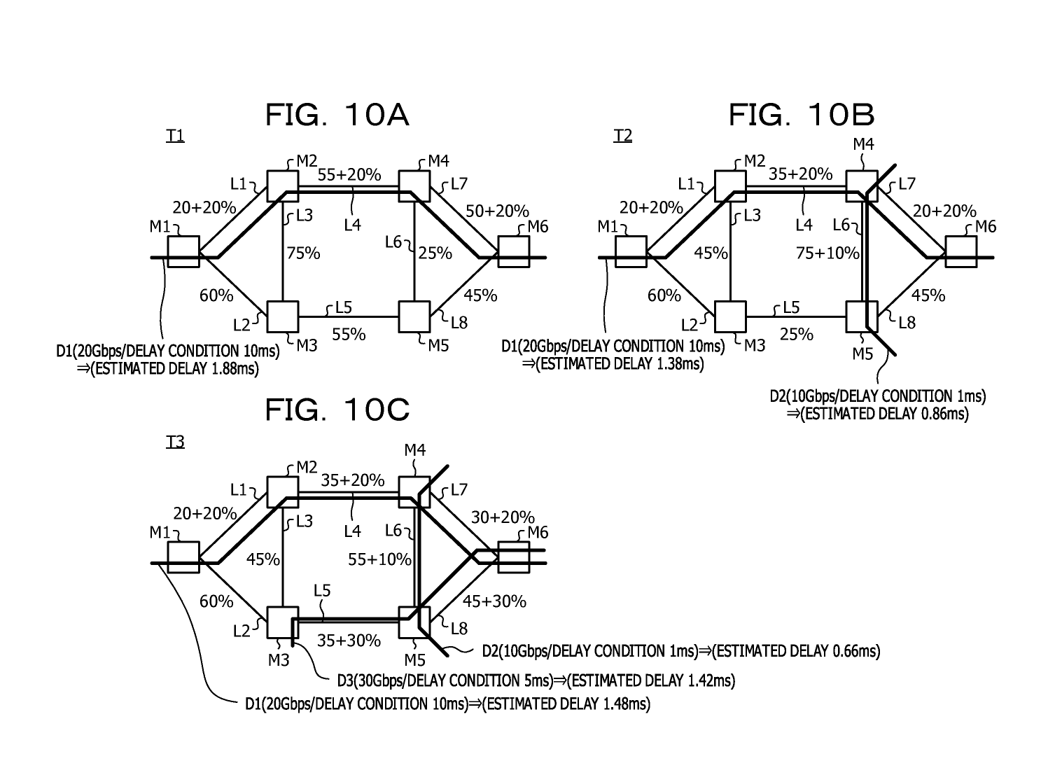

The estimated value of a delay for each of the new demands D1 to D3 may be calculated from the sum or the like of, for example, link delays estimated from individual link load states in a combination pattern of route candidates. FIG. 10A, FIG. 10B, and FIG. 10C are diagrams each illustrating an example of calculation of an estimated delay in a route candidate. In the examples of FIG. 10A, FIG. 10B and FIG. 10C, it is assumed that the slots T1 to T3 are calculated based on the new demands D1 to D3. As for the delay conditions for the new demands D1 to D3, it is assumed that the delay condition for the new demand D1 is defined as 10 ms, the delay condition for the new demand D2 is defined as 1 ms, and the delay condition for the new demand D3 is defined as 5 ms. Furthermore, it is assumed that the traffic loads of already reserved established paths are preliminarily given. Traffic loads in FIGS. 10A to 10C will be described under the assumption that the bandwidth of each of links is 100 Gbps and 100%=100 Gbps is satisfied.

Here, the link delay of each of the links may be expressed by, for example, an estimation function of a link delay, and an example of the estimation function is illustrated in the following Expression (1).

link delay=f(link load)=0.01×link load+0.01 (1)

FIG. 10A illustrates an example of an estimated delay in the slot T1. In the example of FIG. 10A, the route of a path of the new demand D1 passes through the links L1, L4, and L7, and as for traffic loads in the respective links, in combination with traffic loads of established paths, the traffic load of the link L1 is 40%, the traffic load of the link L4 is 75%, and the traffic load of the link L7 is 70%. At this time, the estimated delay of the new demand D1 is expressed in accordance with the following Expression (2).

f(40)+f(75)+f(70)=1.88 ms (2)

FIG. 10B illustrates an example of an estimated delay in the slot T2. In the example of FIG. 10B, the route of a path of the new demand D1 passes through the links L1, L4, and L7, and the route of a path of the new demand D2 passes through the link L6. As for traffic loads in the respective links through which the new demands D1 and D2 pass, in combination with traffic loads of established paths, the traffic load of the link L1 is 40%, the traffic load of the link L4 is 55%, the traffic load of the link L6 is 85%, and the traffic load of the link L7 is 40%. At this time, the estimated delay of the new demand D1 is expressed in accordance with the following Expression (3), and the estimated delay of the new demand D2 is expressed in accordance with the following Expression (4).

f(40)+f(55)+f(40)=1.38 ms (3)

f(85)=0.86 ms (4)

FIG. 10C illustrates an example of an estimated delay in the slot T3. In the example of FIG. 10C, the route of a path of the new demand D1 passes through the links L1, L4, and L7, the route of a path of the new demand D2 passes through the link L6, and the route of a path of the new demand D3 passes through the links L5 and L8. As for traffic loads in the respective links through which the new demands D1, D2, and D3 pass, in combination with traffic loads of established paths, the traffic load of the link L1 is 40%, the traffic load of the link L4 is 55%, the traffic load of the link L5 is 65%, the traffic load of the link L6 is 65%, the traffic load of the link L7 is 50%, and the traffic load of the link L8 is 75%. At this time, the estimated delay of the new demand D1 is expressed in accordance with the following Expression (5), the estimated delay of the new demand D2 is expressed in accordance with the following Expression (6), and the estimated delay of the new demand D3 is expressed in accordance with the following Expression (7).

f(40)+f(55)+f(50)=1.48 ms (5)

f(65)=0.66 ms (6)

f(65)+f(75)=1.42 ms (7)

In accordance with Expressions (2) to (7), the determination unit 233 calculates that the maximum delay of the new demand D1 is 1.88 ms, the maximum delay of the new demand D2 is 0.86 ms, and the maximum delay of the new demand D3 is 1.42 ms. The determination unit 233 calculates a ratio (delay ratio) between a delay condition and an estimated value. The delay ratio of the new demand D1 is expressed by the following Expression (8). The delay ratio of the new demand D2 is expressed by the following Expression (9). The delay ratio of the new demand D3 is expressed by the following Expression (10).

1.88/10=0.188 (8)

0.86/1=0.86 (9)

1.42/5=0.284 (10)

In accordance with Expression (8) to (10), the determination unit 233 calculates that the evaluation value of a combination pattern of the relevant route candidate is 0.86 ms. As described above, the determination unit 233 calculates an evaluation value for each of combination patterns of route candidates and determines, as the route of a path, a route candidate whose evaluation value is minimized.

As illustrated in the following Expression (11), the determination unit 233 may calculate a corresponding evaluation value by adding weight variables p, q, and r in accordance with the priorities of the load distribution policy, the power-saving policy, and the minimum delay policy and may adopt a combination pattern of route candidates, whose evaluation value is minimized.

evaluation value=(weight p×load)+(weight q×electric power)+(weight r×delay ratio) (11)

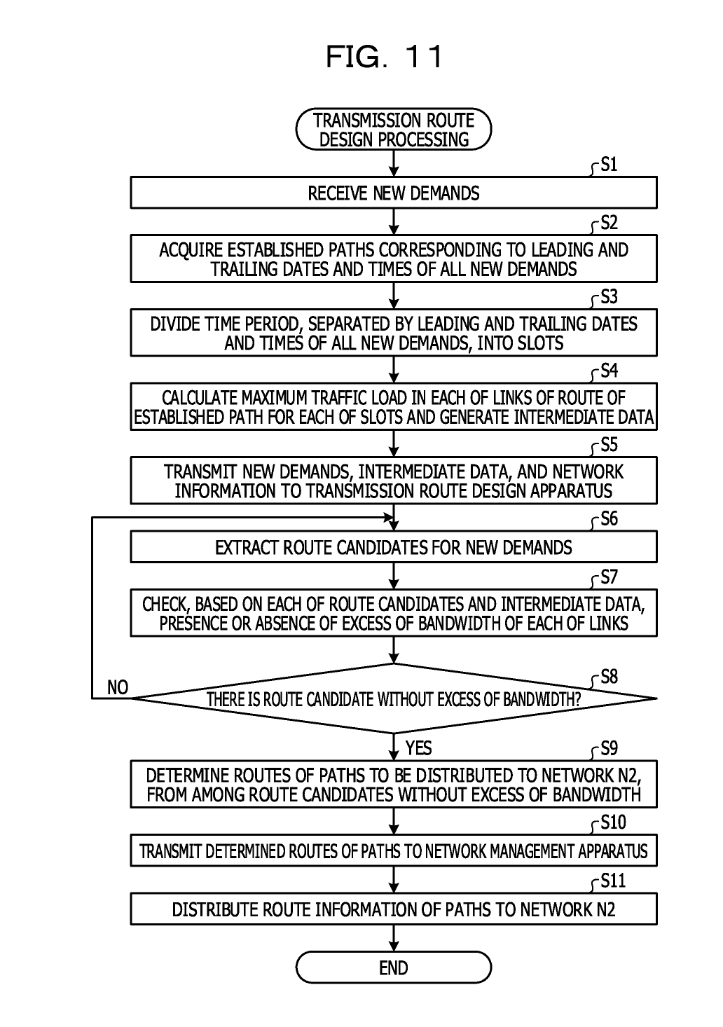

Next, an operation of the transmission route design system 1 of the first example will be described. FIG. 11 is a flowchart illustrating an example of transmission route design processing of the first example.

The reception unit 131 in the network management apparatus 100 receives new demands from the terminal apparatus 10 via the network N1 and the first communication unit 110 (S1). The reception unit 131 outputs the received new demands to the generation unit 132. The generation unit 132 acquires established paths corresponding to the leading and trailing dates and times of all the new demands (S2). If the new demands are input, the generation unit 132 divides a time period, separated by the leading and trailing dates and times of all the new demands, into slots on a temporal axis (S3).

The generation unit 132 calculates a maximum traffic load in each of links of a route of an established path for each of the slots. Upon calculating a maximum traffic load in each of links of a route of an established path for each of the slots, the generation unit 132 stores, as intermediate data, a calculation result in the intermediate data storage unit 122. In other words, the generation unit 132 generates the intermediate data from the calculation result (S4). The generation unit 132 references the NW data storage unit 121, thereby generating network information indicating a network topology and a bandwidth of each of the links. The generation unit 132 transmits the new demands, the intermediate data, and the network information to the transmission route design apparatus 200 via the first communication unit 110 and the network N1 (S5).

The acquisition unit 231 in the transmission route design apparatus 200 acquires the new demands, the intermediate data, and the network information from the network management apparatus 100 via the network N1 and the communication unit 210. The acquisition unit 231 stores the acquired intermediate data in the intermediate data storage unit 221. The acquisition unit 231 outputs the acquired new demands and the acquired network information to the extraction unit 232.

If the new demands and the network information are input by the acquisition unit 231, the extraction unit 232 extracts, based on the network information, route candidates for the new demands (S6). The extraction unit 232 outputs the combination patterns of the extracted route candidates to the determination unit 233.

If the combination patterns of route candidates are input by the extraction unit 232, the determination unit 233 references the intermediate data storage unit 221 and checks, based on each of the route candidates and the intermediate data, the presence or absence of an excess of a bandwidth of each of the links for each of the combination patterns (S7). As a result of the check, the determination unit 233 determines whether or not there is a route candidate without an excess of a bandwidth (S8). In a case where it is determined that there is no route candidate without an excess of a bandwidth (S8: negative), the determination unit 233 returns to S6 and instructs the extraction unit 232 to extract again route candidates for the new demands.

In a case where it is determined that there is route candidates without an excess of a bandwidth (S8: affirmative), the determination unit 233 determines the routes of paths, which are to be distributed to the network N2, from among route candidates without an excess of a bandwidth (S9). The determination unit 233 transmits, as the route information of paths, the determined routes of paths to the network management apparatus 100 via the communication unit 210 and the network N1 (S10).

The distribution unit 133 in the network management apparatus 100 receives the route information of paths from the transmission route design apparatus 200 via the network N1 and the first communication unit 110. Based on the received route information of paths, the distribution unit 133 updates the NW data storage unit 121. The distribution unit 133 distributes the received route information of paths to the network N2 (S11). From this, the transmission route design system 1 determines the routes of the new paths in consideration of the maximum traffic loads of the established paths. Therefore, it is possible to efficiently perform bandwidth allocation on new paths corresponding to the new demands. The transmission route design system 1 is able to reduce states of check points for determining changes in bandwidths of existing paths.

While, in the above-mentioned first example, being performed in the network management apparatus 100, division of slots on the temporal axis, in other words, a setting of slots, and calculation of maximum traffic loads of established paths for each of the slots are not limited to this. The transmission route design apparatus 200 may receive network data from, for example, the network management apparatus 100, store the network data in a NW data storage unit provided in the storage unit 220, and reference the NW data storage unit, thereby performing the division of slots and the calculation of maximum traffic loads.

In this way, the transmission route design apparatus 200 sets slots on the temporal axis in a time period of new demands serving as route requests for paths each including start and end dates and times. In addition, the transmission route design apparatus 200 calculates maximum traffic loads of established paths for each of the slots. In accordance with the maximum traffic loads, the transmission route design apparatus 200 determines routes to be allocated to paths of the new demands. As a result, it is possible to efficiently perform bandwidth allocation.

The transmission route design apparatus 200 receives, from the network management apparatus 100, the maximum traffic loads of established paths for each of the slots specified on the temporal axis in a time period of new demands serving as route requests for paths each including start and end dates and times. In accordance with the received maximum traffic loads, the transmission route design apparatus 200 determines routes to be allocated to paths of the new demands. As a result, it is possible to efficiently perform bandwidth allocation. It is possible to reduce network resource information acquired from the network management apparatus.

The transmission route design apparatus 200 receives the intermediate data and the new demands from the network management apparatus 100. A maximum traffic load of each of links in a network for each of the slots is calculated thereby generating the intermediate data. As for a maximum traffic load in each of links, the network management apparatus 100 receives new demands and divides, into slots, a time period between a start date and time and an end date and time of all the received new demands. In addition, a maximum traffic load in each of links of a route of an established path for each of the slots is calculated. The transmission route design apparatus 200 determines, based on the received intermediate data and the received new demands, routes to be allocated to paths of the new demands. As a result, the routes of the new paths are determined in consideration of the maximum traffic loads of the established paths. Therefore, it is possible to efficiently perform bandwidth allocation on new paths corresponding to the new demands.

The transmission route design apparatus 200 determines routes to be allocated to paths of the new demands so that a load of each of links in a network does not exceed a bandwidth of the relevant link. As a result, it is possible to efficiently perform bandwidth allocation on new paths in consideration of the bandwidth of each of the links.

The transmission route design apparatus 200 receives the intermediate data generated by dividing, into slots, a time period between a start date and time and an end date and time of all new demands for a start or end date and time of each of the new demands. As a result, it is possible to efficiently perform bandwidth allocation on the new paths while not acquiring and not managing all changes in bandwidths in established paths.

The transmission route design apparatus 200 determines routes to be allocated to paths of the new demands so that at least one of a load, power consumption, and a delay of each of links in a network is minimized. As a result, in consideration of at least one of a load, power consumption, and a delay of each of links in a network, it is possible to efficiently perform bandwidth allocation on the new paths.

While, in the above-mentioned first example, route candidates are extracted for the new demands and routes of paths are determined for new paths corresponding to the new demands, determination of routes of paths is not limited to this. Routes of paths may be determined so as to include, for example, a yet-to-be-operated established path out of established paths. An embodiment in this case will be described as a second example hereinafter.

### SECOND EXAMPLE

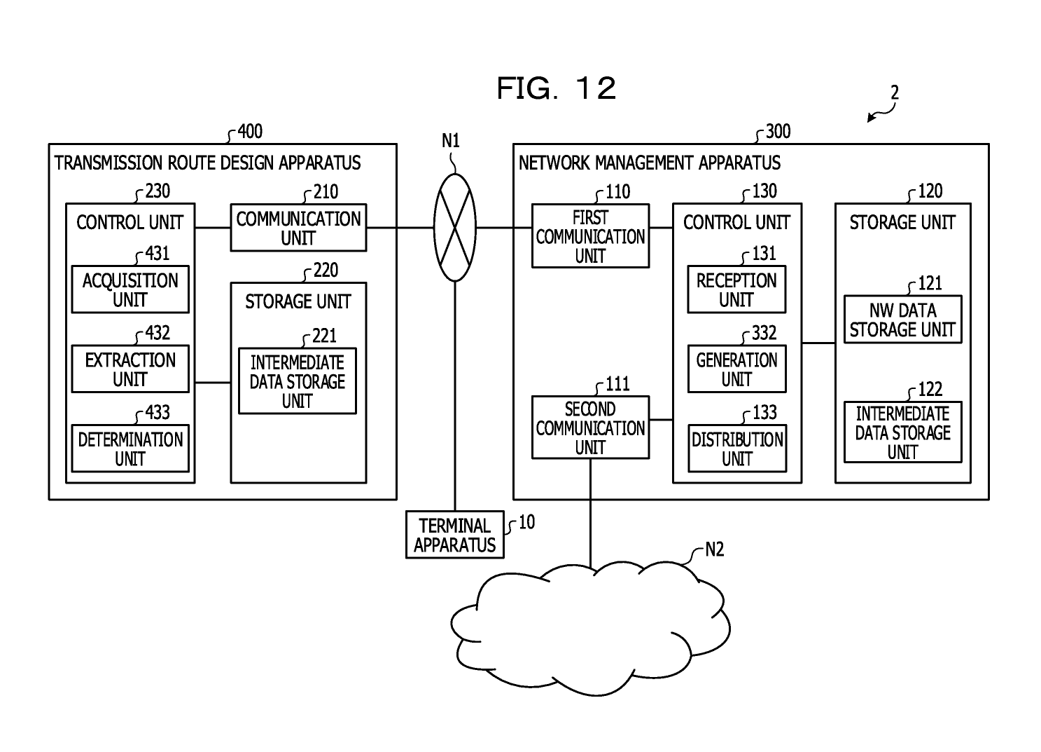

FIG. 12 is a block diagram illustrating an example of a configuration of a transmission route design system of the second example. By assigning the same symbol to the same configuration as that of the transmission route design system 1 of the first example, redundant descriptions of a configuration and an operation thereof will be omitted. A transmission route design system 2 of the second example is different from the transmission route design system 1 of the first example in that a yet-to-be-operated established path is set for a redesign demand and routes of paths of a new demand and the redesign demand are determined.

The transmission route design system 2 of the second example includes the terminal apparatus 10, a network management apparatus 300, and a transmission route design apparatus 400. The terminal apparatus 10, the network management apparatus 300, and the transmission route design apparatus 400 are connected so as to be able to intercommunicate with each other via the network N1. The network management apparatus 300 manages resources of the network N2.

The network management apparatus 300 is different from the network management apparatus 100 in including a generation unit 332 in place of the generation unit 132. The transmission route design apparatus 400 is different from the transmission route design apparatus 200 in including an acquisition unit 431, an extraction unit 432, and a determination unit 433 in place of the acquisition unit 231, the extraction unit 232, and the determination unit 233, respectively.

If new demands are input by the reception unit 131, the generation unit 332 in the network management apparatus 300 references the NW data storage unit 121, thereby generating intermediate data. The generation unit 332 acquires, from the NW data storage unit 121, established paths corresponding to a time period RT1 between a start date and time and an end date and time of all the new demands. In other words, the generation unit 332 acquires, from the NW data storage unit 121, established paths corresponding to the leading and trailing dates and times of all the new demands. From among the acquired established paths, the generation unit 332 sets a yet-to-be-operated established path for a redesign demand. The generation unit 332 may treat, as an established path, an arbitrary established path out of yet-to-be-operated established paths while not setting the arbitrary established path for the redesign demand. The generation unit 332 divides a time period, separated by the leading and trailing dates and times of all the new demands and the redesign demand, into slots.

For each of the divided slots, the generation unit 332 calculates a maximum traffic load in each of links of routes of established paths not set for the redesign demand, in other words, currently operated paths. Upon calculating a maximum traffic load of each of the links in each of the slots, the generation unit 332 stores, as intermediate data, a calculation result in the intermediate data storage unit 122. The generation unit 332 references the NW data storage unit 121, thereby generating network information indicating a network topology and a bandwidth of each of the links. The generation unit 332 transmits the new demands, the redesign demand, the intermediate data, and the network information to the transmission route design apparatus 400 via the first communication unit 110 and the network N1.

The acquisition unit 431 in the transmission route design apparatus 400 acquires the new demands, the redesign demand, the intermediate data, and the network information from the network management apparatus 300 via the network N1 and the communication unit 210. The acquisition unit 431 stores the acquired intermediate data in the intermediate data storage unit 221. The acquisition unit 431 outputs the acquired new demands, redesign demand, and network information to the extraction unit 432.

If the new demands, the redesign demand, and the network information are input by the acquisition unit 431, the extraction unit 432 extracts, based on the network information, route candidates for the new demands and the redesign demand. In a case where there are, for example, the new demands and the redesign demand, the extraction unit 432 extracts route candidates for the individual new demands and the redesign demand. In addition, the extraction unit 432 further extracts combination patterns of the extracted route candidates. The extraction unit 432 outputs the combination patterns of the extracted route candidates to the determination unit 433. Upon being instructed by the determination unit 433 to extract again route candidates for the new demands and the redesign demand, the extraction unit 432 extracts combination patterns of route candidates by changing, for example, extraction conditions and outputs the combination patterns of route candidates to the determination unit 433.

If the combination patterns of route candidates are input by the extraction unit 432, the determination unit 433 references the intermediate data storage unit 221. In addition, the determination unit 433 checks, based on each of the route candidates and the intermediate data, the presence or absence of an excess of a bandwidth of each of the links for each of the combination patterns. In other words, for each of links in the network N2, the determination unit 433 determines whether or not there is a route candidate without an excess of a bandwidth for each of the combination patterns.

In a case where there is no route candidate without an excess of a bandwidth, the determination unit 433 instructs the extraction unit 432 to change, for example, extraction conditions of route candidates for the new demands and the redesign demand and to perform extraction again. In a case where there is a route candidate without an excess of a bandwidth, the determination unit 433 determines the routes of paths, which are to be distributed to the network N2, from among route candidates without an excess of a bandwidth. The determination unit 433 transmits, as the route information of paths, the determined routes of paths to the network management apparatus 300 via the communication unit 210 and the network N1. In a case where there are route candidates without an excess of a bandwidth, the determination unit 433 is able to determine the route of a path in the same way as in the first example.

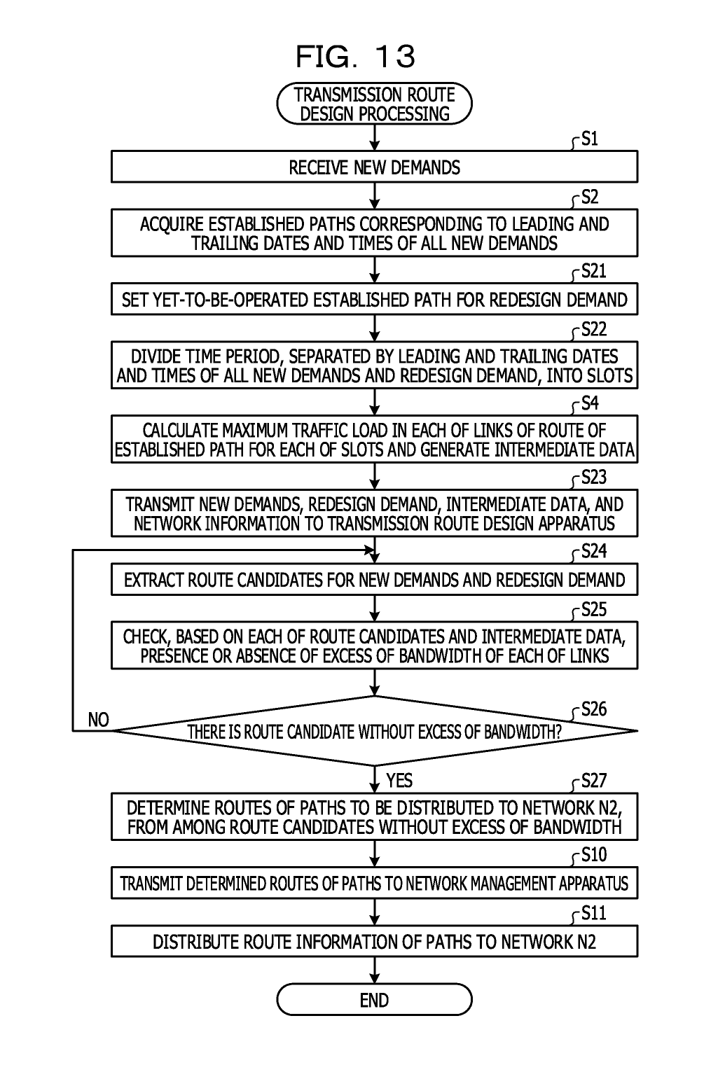

Next, an operation of the transmission route design system 2 of the second example will be described. FIG. 13 is a flowchart illustrating an example of transmission route design processing of the second example.

The reception unit 131 in the network management apparatus 300 receives new demands from the terminal apparatus 10 via the network N1 and the first communication unit 110 (S1). The reception unit 131 outputs the received new demands to the generation unit 332. The generation unit 332 acquires established paths corresponding to the leading and trailing dates and times of all the new demands (S2). The generation unit 332 sets, for the redesign demand, a yet-to-be-operated established path out of the acquired established paths (S21).

The generation unit 332 divides a time period, separated by the leading and trailing dates and times of all the new demands and the redesign demand, into slots (S22). For each of the divided slots, the generation unit 332 calculates a maximum traffic load in each of links of a route of an established path not set for the redesign demand. Upon calculating a maximum traffic load in each of the links in each of the slots, the generation unit 332 stores, as intermediate data, a calculation result in the intermediate data storage unit 122. In other words, the generation unit 132 generates the intermediate data from the calculation result (S4). The generation unit 332 references the NW data storage unit 121, thereby generating network information indicating a network topology and a bandwidth of each of the links. The generation unit 332 transmits the new demands, the redesign demand, the intermediate data, and the network information to the transmission route design apparatus 400 via the first communication unit 110 and the network N1 (S23).

The acquisition unit 431 in the transmission route design apparatus 400 acquires the new demands, the redesign demand, the intermediate data, and the network information from the network management apparatus 300 via the network N1 and the communication unit 210. The acquisition unit 431 stores the acquired intermediate data in the intermediate data storage unit 221. The acquisition unit 431 outputs the acquired new demands, redesign demand, and network information to the extraction unit 432.

If the new demands, the redesign demand, and the network information are input by the acquisition unit 431, the extraction unit 432 extracts, based on the network information, route candidates for the new demands and the redesign demand (S24). The extraction unit 432 outputs the combination patterns of the extracted route candidates to the determination unit 433.

If the combination patterns of route candidates are input by the extraction unit 432, the determination unit 433 references the intermediate data storage unit 221. In addition, the determination unit 433 checks, based on each of the route candidates and the intermediate data, the presence or absence of an excess of a bandwidth of each of the links for each of the combination patterns (S25). As a result of the check, the determination unit 433 determines whether or not there is a route candidate without an excess of a bandwidth (S26). In a case where it is determined that there is no route candidate without an excess of a bandwidth (S26: negative), the determination unit 433 returns to S24 and instructs the extraction unit 432 to extract again route candidates for the new demands and the redesign demand.

In a case where it is determined that there is route candidates without an excess of a bandwidth (S26: affirmative), the determination unit 433 determines the routes of paths, which are to be distributed to the network N2, from among route candidates without an excess of a bandwidth (S27). The determination unit 433 transmits, as the route information of paths, the determined routes of paths to the network management apparatus 300 via the communication unit 210 and the network N1 (S10).

The distribution unit 133 in the network management apparatus 300 receives the route information of paths from the transmission route design apparatus 400 via the network N1 and the first communication unit 110. Based on the received route information of paths, the distribution unit 133 updates the NW data storage unit 121. The distribution unit 133 distributes the received route information of paths to the network N2 (S11). From this, the transmission route design system 2 allocates a route to the redesign demand along with the new demands while setting, for the redesign demand, a yet-to-be-operated established path out of established paths. Therefore, it is possible to more efficiently perform bandwidth allocation.

In this way, the transmission route design apparatus 400 receives the intermediate data, the new demands, and the redesign demand from the network management apparatus 300. A maximum traffic load of each of links in a network for each of the slots is calculated thereby generating the intermediate data. As for a maximum traffic load in each of links, a maximum traffic load in each of links of a route of a currently operated established path for each of the slots is calculated. As for the slots, the network management apparatus 300 sets a yet-to-be-operated established path for the redesign demand. In addition, a time period between a start date and time and an end date and time of all the new demands and the redesign demand is divided into slots. The transmission route design apparatus 400 determines, based on the received intermediate data, new demands, and redesign demand, routes to be allocated to paths of the new demands and the redesign demand. As a result, it is possible to more efficiently perform bandwidth allocation.

While, in the above-mentioned first example, the presence or absence of an excess of a bandwidth of each of links for each of combination patterns of route candidates is checked based on the new demands, the intermediate data, and the network information and routes of paths to be distributed to the network N2 are determined, determination of routes of paths is not limited to this. Based on, for example, the new demands, the intermediate data, and the network information, routes of paths to be distributed to the network N2 may be determined using a mathematical programming problem. An embodiment in this case will be described as a third example hereinafter.

### THIRD EXAMPLE

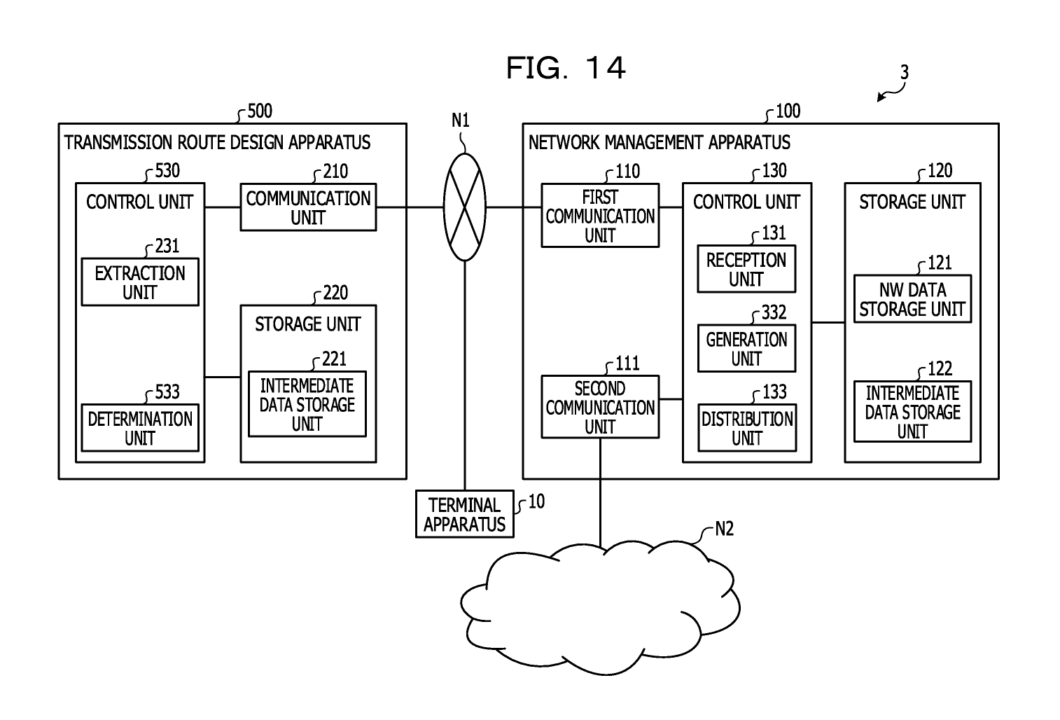

FIG. 14 is a block diagram illustrating an example of a configuration of a transmission route design system of the third example. By assigning the same symbol to the same configuration as that of the transmission route design system 1 of the first example, redundant descriptions of a configuration and an operation thereof will be omitted. A transmission route design system 3 of the third example is different from the transmission route design system 1 of the first example in that a route of a path is determined using the mathematical programming problem.

The transmission route design system 3 of the third example includes the terminal apparatus 10, the network management apparatus 100, and a transmission route design apparatus 500. The terminal apparatus 10, the network management apparatus 100, and the transmission route design apparatus 500 are connected so as to be able to intercommunicate with each other via the network N1. The network management apparatus 100 manages resources of the network N2.

The transmission route design apparatus 500 is different from the transmission route design apparatus 200 in including a control unit 530 in place of the control unit 230. The control unit 530 is different from the control unit 230 in including a determination unit 533 in place of the determination unit 233 while not including the extraction unit 232. The acquisition unit 231 in the control unit 530 is different in outputting an acquired new demand and acquired network information to the determination unit 533.

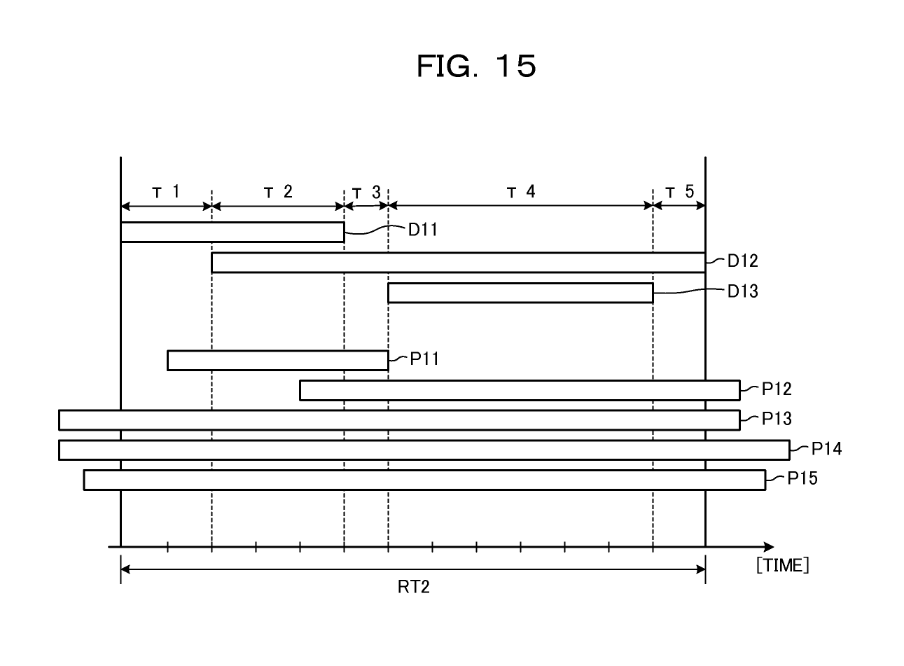

If new demands and network information are input by the acquisition unit 231, the determination unit 533 references the intermediate data storage unit 221, thereby determining, by using the mathematical programming problem, routes of paths to be distributed to the network N2. FIG. 15 is a diagram illustrating another example of a relationship between reservations for established paths and new demands. In the example of FIG. 15, the determination unit 533 determines routes of paths of new demands D11 to D13 for the network N2 in which established paths P11 to P15 are reserved.

The determination unit 533 divides a time period RT2 between a start date and time of the new demand D11 and an end date and time of the new demand D12 into time periods, separated by a start date and time or an end date and time of each of the new demands D11 to D13, in other words, slots. In other words, the determination unit 533 divides the time period RT2, separated by the leading and trailing dates and times of all the new demands, into slots τ1 to τ5. Here, the slot τ1 is a time period separated by the start date and time of the new demand D11 and the start date and time of the new demand D12. The slot τ2 is a time period separated by the start date and time of the new demand D12 and the end date and time of the new demand D11. The slot τ3 is a time period separated by the end date and time of the new demand D11 and the start date and time of the new demand D13. The slot τ4 is a time period separated by the start date and time of the new demand D13 and the end date and time of the new demand D13. The slot τ5 is a time period separated by the end date and time of the new demand D13 and the end date and time of the new demand D12. The determination unit 533 may acquire information of each of slots with reference to the intermediate data storage unit 221.

The determination unit 533 generates a traffic constraint condition for each of the slot τ1 to τ5. In addition, the determination unit 533 references the intermediate data storage unit 221 and performs route design, based on the mathematical programming. Here, a case of solving by reducing to the mathematical programming, in other words, the mathematical programming problem will be described. First, input parameters will be described. B^{(s,d)} indicates a requested bandwidth between a starting point (s) and an ending point (d) of a new demand, and a unit thereof is bps. Eₘ indicates an electric power characteristic of a node m, and a unit thereof is W/bps. RD^{(s,d)} indicates a requested delay between the starting point (s) and the ending point (d) of the new demand, and a unit thereof is ms. f( ) indicates a delay estimation function, and the function illustrated in, for example, Expression (1) in the first example may be used.

Lt_{(m,n)}^{τ} Character 1

indicates a maximum traffic amount for a (m,n) link within a slot τ, and a unit thereof is bps. “m,n” indicates nodes at the two ends of the corresponding link.

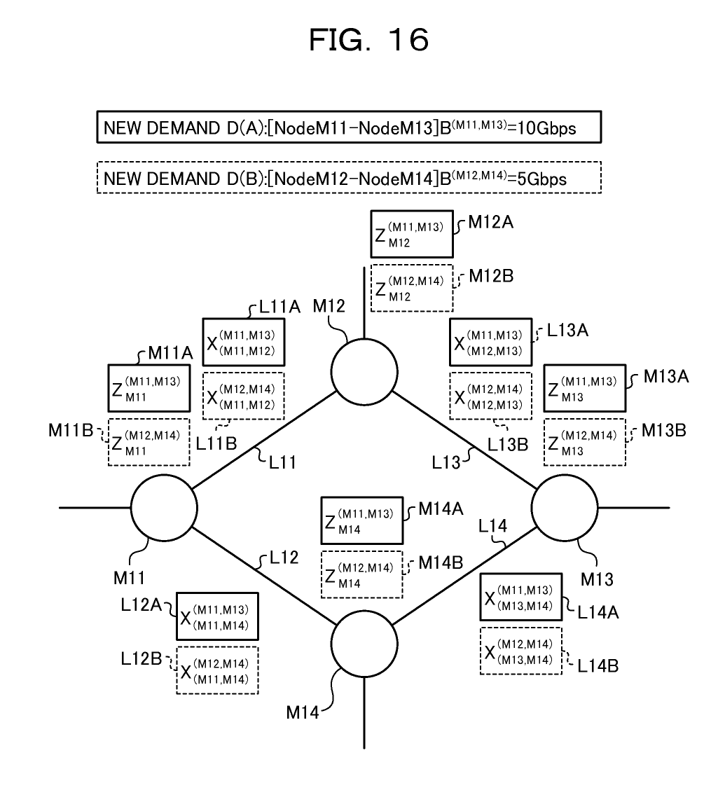

Next, using FIG. 16, variable definitions of each of new demands will be described. FIG. 16 is a diagram illustrating examples of variable definitions of each of the new demands. The examples in the FIG. 16 correspond to a case where a new demand D(A) and a new demand D(B) are allocated to a network including nodes M11 to M14 and links L11 to L14. It is assumed that a start node of the new demand D(A) is M11, an end node thereof is M13, and a requested bandwidth from the node M11 to the node M13 is 10 Gbps. It is assumed that a start node of the new demand D(B) is M12, an end node thereof is M14, and a requested bandwidth from the node M12 to the node M14 is 5 Gbps.

Here, in FIG. 16, whether or not a new demand is routed through each of the nodes M11 to M14 is indicated by the following Expression (12). In FIG. 16, whether or not a new demand uses each of the links L11 to L14 is indicated by the following Expression (13). It is assumed that a link load maximum value Tr^{τ} within a slot τ is a condition indicated by the following Expression (14). In the same way, it is assumed that a link load maximum value Tr in a design target interval, in other words, between starting and ending points of a new demand is a condition indicated by the following Expression (15). Furthermore, it is assumed that a delay ratio maximum value D^{τ} within a slot τ is a condition indicated by the following Expression (16). In the same way, it is assumed that a delay ratio maximum value D in a design target interval, in other words, between the starting and ending points of the new demand is a condition indicated by the following Expression (17).

Zₘ^{(s,d)} ∈ {0,1} (12)

X_{(m,n)}^{(s,d)} ∈ {0,1} (13)

Tr^{τ} ∈ real numbers (14)

Tr ∈ real numbers (15)

D^{τ} ∈ real numbers (16)

D ∈ real numbers (17)

In the examples in FIG. 16, as for variable definitions of the new demand D(A), the nodes M11 to M14 may be expressed by, for example, definitions M11A, M12A, M13A, and M14A, respectively. The links L11 to L14 may be expressed by, for example, definitions L11A, L12A, L13A, and L14A, respectively. In the same way, as for variable definitions of the new demand D(B), the nodes M11 to M14 may be expressed by, for example, definitions M11B, M12B, M13B, and M14B, respectively. The links L11 to L14 may be expressed by, for example, definitions L11B, L12B, L13B, and L14B, respectively.

The determination unit 533 defines the objective function of the load distribution policy as the following Expression (18), defines the objective function of the power consumption policy as the following Expression (19), and defines the objective function of the delay minimization policy as the following Expression (20).

$$\begin{matrix}Minimize Tr & ( 18 ) \\ Minimize {\sum }_{m} {\sum }_{( s , d )} {E}_{m} {B}^{( s , d )} {Z}_{m}^{( s , d )} & ( 19 ) \\ Minimize D & ( 20 )\end{matrix}$$

The determination unit 533 defines the constraint conditions of route generation constraints as the following Expressions (21) to (23), defines the constraint condition of a maximum used bandwidth for each of slots τ as the following Expression (24), and defines the constraint condition of a maximum traffic amount of the entire network as the following Expression (25). Tr^{τ} and Tr may be calculated based on the intermediate data. The determination unit 533 defines the constraint condition of a maximum delay ratio for each of slots τ as the following Expression (26) and defines the constraint condition of a maximum delay ratio as the following Expression (27).

$$\begin{matrix}{\sum }_{k} {X}_{( m , k )}^{( s , d )} = {Z}_{m}^{( i , d )} , ∀ m = \{ {i}_{s} or {e}_{d} \} & ( 21 ) \\ {Z}_{m}^{( s , d )} = 1 , ∀ m = \{ s or d \} & ( 22 ) \\ {\sum }_{k} {X}_{( m , k )}^{( s , d )} = 2 {Z}_{m}^{( s , d )} , ∀ m \neq \{ {i}_{s} or {e}_{d} \} & ( 23 ) \\ {\sum }_{( s , d )} {B}^{( s , d )} {X}_{( m , n )}^{( s , d )} + L {t}_{( m , n )}^{τ} \leq T {r}^{τ} , ∀ ( m , n ) , τ & ( 24 ) \\ T {r}^{τ} \leq T r ∀ τ & ( 25 ) \\ \frac{f ( {\sum }_{( s , d )} {B}^{( s , d )} {X}_{( m , n )}^{( s , d )} + L {t}_{( m , n )}^{τ} )}{{RD}^{( s , d )}} \leq {D}^{τ} , ∀ ( s , d ) , ( m , n ) , τ & ( 26 ) \\ {D}^{τ} \leq D ∀ τ & ( 27 )\end{matrix}$$

By solving the mathematical programming problem under these conditions, the determination unit 533 is able to uniquely derive a route solution for optimizing a specified policy with respect to the new demands. The determination unit 533 determines the derived route solution as routes of paths. The determination unit 533 transmits, as the route information of paths, the determined routes of paths to the network management apparatus 100 via the communication unit 210 and the network N1.

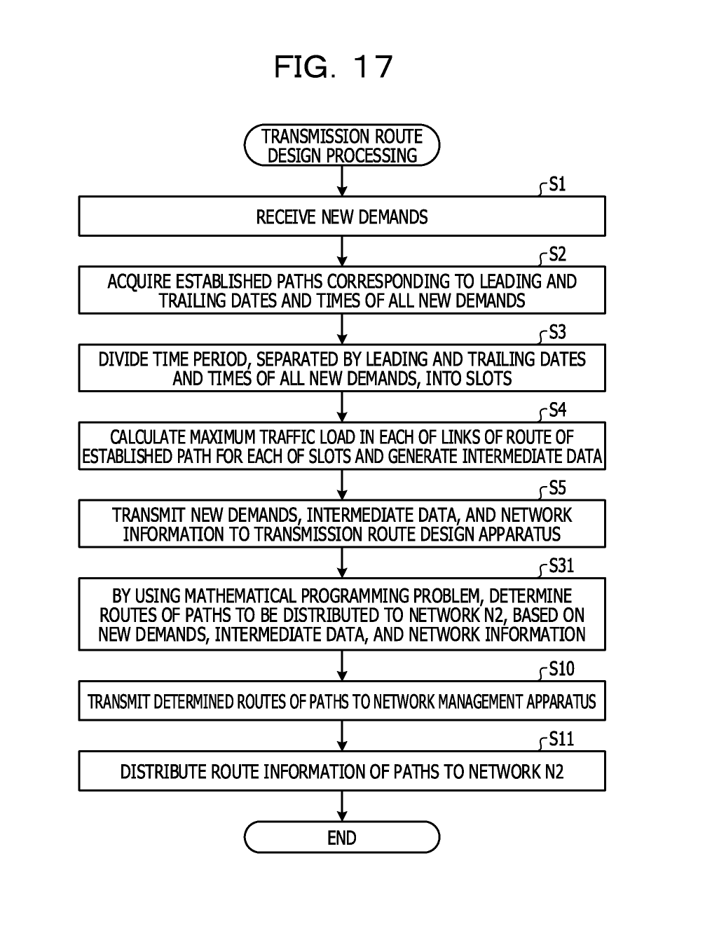

Next, an operation of the transmission route design system 3 of the third example will be described. FIG. 17 is a flowchart illustrating an example of transmission route design processing of the third example.

The reception unit 131 in the network management apparatus 100 receives new demands from the terminal apparatus 10 via the network N1 and the first communication unit 110 (S1). The reception unit 131 outputs the received new demands to the generation unit 132. The generation unit 132 acquires established paths corresponding to the leading and trailing dates and times of all the new demands (S2). If the new demands are input, the generation unit 132 divides a time period, separated by the leading and trailing dates and times of all the new demands, into slots on the temporal axis (S3).

The generation unit 132 calculates a maximum traffic load in each of links of a route of an established path for each of the slots. Upon calculating a maximum traffic load in each of links of a route of an established path for each of the slots, the generation unit 132 stores, as intermediate data, a calculation result in the intermediate data storage unit 122. In other words, the generation unit 132 generates the intermediate data from the calculation result (S4). The generation unit 132 references the NW data storage unit 121, thereby generating network information indicating a network topology and a bandwidth of each of the links. The generation unit 132 transmits the new demands, the intermediate data, and the network information to the transmission route design apparatus 500 via the first communication unit 110 and the network N1 (S5).

The acquisition unit 231 in the transmission route design apparatus 500 acquires the new demands, the intermediate data, and the network information from the network management apparatus 100 via the network N1 and the communication unit 210. The acquisition unit 231 stores the acquired intermediate data in the intermediate data storage unit 221. The acquisition unit 231 outputs the acquired new demands and the acquired network information to the determination unit 533.

If the new demands and the network information are input by the acquisition unit 231, the determination unit 533 references the intermediate data storage unit 221, thereby determining, by using the mathematical programming problem, routes of paths to be distributed to the network N2 (S31). The determination unit 533 transmits, as the route information of paths, the determined routes of paths to the network management apparatus 100 via the communication unit 210 and the network N1 (S10).

The distribution unit 133 in the network management apparatus 100 receives the route information of paths from the transmission route design apparatus 500 via the network N1 and the first communication unit 110. Based on the received route information of paths, the distribution unit 133 updates the NW data storage unit 121. The distribution unit 133 distributes the received route information of paths to the network N2 (S11). From this, by solving the mathematical programming problem, the transmission route design system 3 is able to uniquely derive a route solution for optimizing a specified policy with respect to the new demands. The transmission route design system 3 is able to efficiently perform bandwidth allocation on new paths corresponding to the new demands.

In this way, by solving the mathematical programming problem, the transmission route design apparatus 500 determines routes to be allocated to paths of the new demands. As a result, it is possible to efficiently perform bandwidth allocation in accordance with the specified policy.

While, in the above-mentioned first to third examples, a network in which statistical multiplexing, for example, packet communication is performed is used as the network N2, the network N2 is not limited to this. For example, a time division multiplexing (TDM) network may be used. An embodiment in this case will be described as a fourth example hereinafter.

### FOURTH EXAMPLE

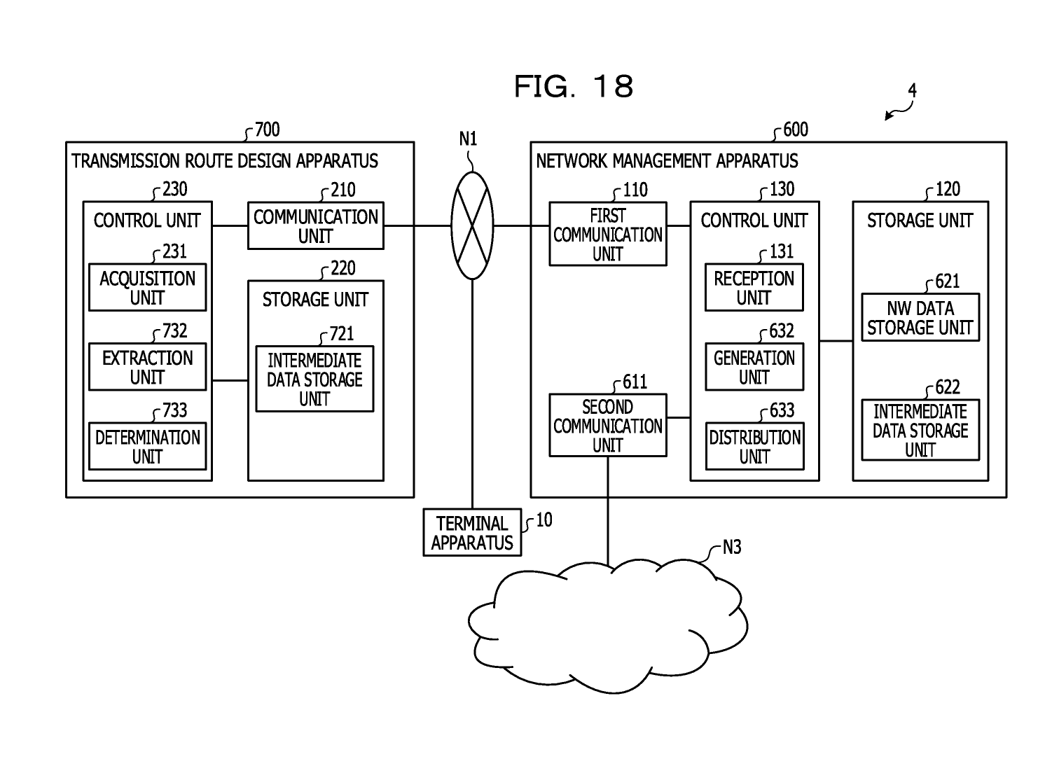

FIG. 18 is a block diagram illustrating an example of a configuration of a transmission route design system of the fourth example. By assigning the same symbol to the same configuration as that of the transmission route design system 1 of the first example, redundant descriptions of a configuration and an operation thereof will be omitted. A transmission route design system 4 of the fourth example is different from the transmission route design system 1 of the first example in being applied to a TDM network.

The transmission route design system 4 of the fourth example includes the terminal apparatus 10, a network management apparatus 600, and a transmission route design apparatus 700. The terminal apparatus 10, the network management apparatus 600, and the transmission route design apparatus 700 are connected so as to be able to intercommunicate with each other via the network N1. The network management apparatus 600 manages resources of a network N3. Here, the network N3 is, for example, the TDM network.

The network management apparatus 600 is different from the network management apparatus 100 in including a second communication unit 611, a generation unit 632, and a distribution unit 633 in place of the second communication unit 111, the generation unit 132, and the distribution unit 133, respectively. The network management apparatus 600 is different from the network management apparatus 100 in including a NW data storage unit 621 and an intermediate data storage unit 622 in place of the NW data storage unit 121 and the intermediate data storage unit 122, respectively.

The transmission route design apparatus 700 is different from the transmission route design apparatus 200 in including an extraction unit 732 and a determination unit 733 in place of the extraction unit 232 and the determination unit 233, respectively. The transmission route design apparatus 700 is different from the transmission route design apparatus 200 in including an intermediate data storage unit 721 in place of the intermediate data storage unit 221.

The second communication unit 611 in the network management apparatus 600 is realized by, for example, an NIC or the like. The second communication unit 611 is a communication interface that is wirelessly or wiredly connected to individual nodes of the network N3, not illustrated, and that manages communication of information with the individual nodes of the network N3. The second communication unit 611 receives information of the individual nodes or the like and outputs the received information of the individual nodes to the control unit 130. The second communication unit 611 transmits route information of paths, input by the control unit 130, to the individual nodes of the network N3.

The NW data storage unit 621 stores therein usage states of the resources of the network N3. The NW data storage unit 621 has the same configuration as that of the NW data storage unit 121 in the first example. However, the NW data storage unit 621 stores therein information of time slots obtained by equally dividing a time period of TDM of the network N3. In the following description, in order to be differentiated from time slots of the TDM, slots obtained by dividing a time period of new demands corresponding to the slots of the first to third examples are expressed as design interval slots.

The intermediate data storage unit 622 stores therein intermediate data indicating the number of continuously available time slots of the TDM. In other words, for each of design interval slots obtained by dividing a time period between a start date and time and an end date and time of all new demands, the intermediate data storage unit 622 stores therein the number of free spaces (bandwidths) for which time slots of each of links are continuously available. In a case where a design interval slot is set to, for example, 24 hours, the number of continuously available time slots is the number of divided bandwidths continuously available for 24 hours. Here, it is assumed that the entire bandwidth of a link is, for example, 2.4 Gbps and there are 48 bandwidths of 1st to 48th bandwidths divided in units of 50 Mbps. At this time, in a case where it is assumed that existing paths cause 21 bandwidths of, for example, the 1st to 24th bandwidths to be already allocated between 0 hours and 3 hours and cause 9 bandwidths of, for example, the 40th to 48th bandwidths to be already allocated between 20 hours and 24 hours, the number of continuously available time slots, in other words, the number of bandwidths continuously free between 0 hours and 24 hours is 18 including the 22nd to 39th bandwidths. In other words, the number of continuously available time slots of the TDM is 18, and a bandwidth continuously available for 24 hours is 900 Mbps.

If new demands are input by the reception unit 131, the generation unit 632 references the NW data storage unit 621, thereby generating intermediate data. The generation unit 632 acquires, from the NW data storage unit 621, established paths corresponding to the leading and trailing dates and times of all the new demands. The generation unit 632 references the NW data storage unit 621 and generates the intermediate data indicating the number of continuously available time slots of the TDM in a time period separated by the leading and trailing dates and times of all the new demands. The generation unit 632 stores the generated intermediate data in the intermediate data storage unit 622. The generation unit 632 references the NW data storage unit 621, thereby generating network information indicating a network topology and time slots of each of links. The generation unit 632 transmits the new demands, the intermediate data, and the network information to the transmission route design apparatus 700 via the first communication unit 110 and the network N1.

The distribution unit 633 receives route information of paths from the transmission route design apparatus 700 via the network N1 and the first communication unit 110. Based on the received route information of paths, the distribution unit 633 updates the NW data storage unit 621. The distribution unit 633 transmits the received route information of paths to the individual nodes of the network N3 via the second communication unit 611, thereby distributing the route information of paths to the network N3.

The intermediate data storage unit 721 in the transmission route design apparatus 700 stores therein the intermediate data received from the network management apparatus 600. Since the configuration of the intermediate data storage unit 721 is the same as that of the intermediate data storage unit 622 in the network management apparatus 600, the description thereof will be omitted.

If a new demand and the network information are input by the acquisition unit 231, the extraction unit 732 extracts, based on the network information, a route candidate for the new demand. In a case where there are, for example, new demands, the extraction unit 732 extracts route candidates for the individual new demands and furthermore extracts combination patterns of the extracted route candidates. The extraction unit 732 outputs the combination patterns of the extracted route candidates to the determination unit 733. Upon being instructed by the determination unit 733 to extract again route candidates for the new demands, the extraction unit 732 extracts combination patterns of route candidates by changing, for example, extraction conditions and outputs the combination patterns of route candidates to the determination unit 733.

If the combination patterns of route candidates are input by the extraction unit 732, the determination unit 733 references the intermediate data storage unit 721 and checks, based on each of the route candidates and the intermediate data, whether or not the relevant route candidate falls within the time slots of each of links for each of the combination patterns. In other words, for each of links in the network N3, the determination unit 733 determines whether or not there is a route candidate that falls within the time slots of the relevant link, for each of the combination patterns.

In a case where there is no route candidate that falls within the time slots of each of links, the determination unit 733 instructs the extraction unit 732 to change, for example, extraction conditions of route candidates for the new demands and to perform extraction again. In a case where there is a route candidate that falls within the time slots of each of links, the determination unit 733 determines the route of paths, which are to be distributed to the network N3, from among route candidates that each fall within the time slots of each of links. In the same way as, for example, the first example, the determination unit 733 determines, as the route of a path, which is to be distributed to the network N3, a route candidate that satisfies a load distribution policy, a power-saving policy, and a minimum delay policy. The determination unit 733 transmits, as the route information of paths, the determined routes of paths to the network management apparatus 600 via the communication unit 210 and the network N1.

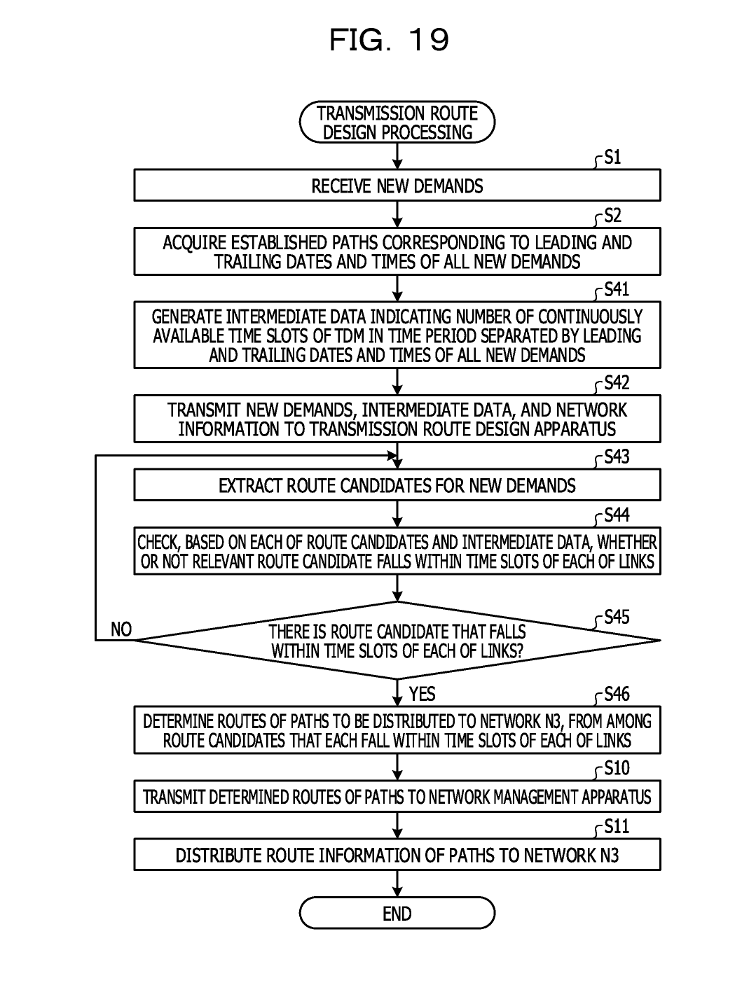

Next, an operation of the transmission route design system 4 of the fourth example will be described. FIG. 19 is a flowchart illustrating an example of transmission route design processing of the fourth example.

The reception unit 131 in the network management apparatus 600 receives new demands from the terminal apparatus 10 via the network N1 and the first communication unit 110 (S1). The reception unit 131 outputs the received new demands to the generation unit 632. The generation unit 632 acquires established paths corresponding to the leading and trailing dates and times of all the new demands (S2). If the new demands are input, the generation unit 632 generates intermediate data indicating the number of continuously available time slots of the TDM in a time period separated by the leading and trailing dates and times of all the new demands. (S41).

The generation unit 632 stores the generated intermediate data in the intermediate data storage unit 622. The generation unit 632 references the NW data storage unit 621, thereby generating network information indicating a network topology and time slots of each of links. The generation unit 632 transmits the new demands, the intermediate data, and the network information to the transmission route design apparatus 700 via the first communication unit 110 and the network N1 (S42).

The acquisition unit 231 in the transmission route design apparatus 700 acquires the new demands, the intermediate data, and the network information from the network management apparatus 600 via the network N1 and the communication unit 210. The acquisition unit 231 stores the acquired intermediate data in the intermediate data storage unit 721. The acquisition unit 231 outputs the acquired new demands and the acquired network information to the extraction unit 732.

If the new demands and the network information are input by the acquisition unit 231, the extraction unit 732 extracts, based on the network information, route candidates for the new demands (S43). The extraction unit 732 outputs the combination patterns of the extracted route candidates to the determination unit 733.

The combination patterns of route candidates are input to the determination unit 733 by the extraction unit 732. The determination unit 733 references the intermediate data storage unit 721 and checks, based on each of the route candidates and the intermediate data, whether or not the relevant route candidate falls within the time slots of each of links for each of the combination patterns (S44). As a result of the check, the determination unit 733 determines whether or not there is a route candidate that falls within the time slots of each of links (S45). In a case where it is determined that there is no route candidate that falls within the time slots of each of links (S45: negative), the determination unit 733 returns to S43 and instructs the extraction unit 732 to extract route candidates for the new demands again.

In a case where it is determined that there is a route candidate that falls within the time slots of each of links (S45: affirmative), the determination unit 733 determines the routes of paths, which are to be distributed to the network N3, from among route candidates that each fall within the time slots of each of links (S46). The determination unit 733 transmits, as the route information of paths, the determined routes of paths to the network management apparatus 600 via the communication unit 210 and the network N1 (S10).

The distribution unit 633 in the network management apparatus 600 receives route information of paths from the transmission route design apparatus 700 via the network N1 and the first communication unit 110. Based on the received route information of paths, the distribution unit 633 updates the NW data storage unit 621. The distribution unit 633 distributes the received route information of paths to the network N3 (S11). From this, the transmission route design system 4 determines the routes of the new paths in consideration of free states of time slots of each of links. Therefore, it is possible to efficiently perform bandwidth allocation on new paths corresponding to the new demands of the TDM network.

In this way, the transmission route design apparatus 700 receives the intermediate data and the new demands from the network management apparatus 600. The network management apparatus 600 receives the new demands as route requests of paths each including start and end dates and times. The number of continuously available time slots obtained by equally dividing a time period of the TDM is calculated in a time period between a start date and time and an end date and time of all the received new demands, thereby generating the intermediate data. The transmission route design apparatus 700 determines, based on the received intermediate data and new demands, routes to be allocated to paths of the new demands. As a result, it is possible to efficiently perform bandwidth allocation on new paths corresponding to the new demands of the TDM network.

While, in the above-mentioned first to third examples, the intermediate data is generated using an already reserved used bandwidth or a utilization rate, generation of the intermediate data is not limited to this. The intermediate data may be generated using, for example, a remaining bandwidth of each of links or a remaining utilization rate thereof.

Individual configuration elements in individual units illustrated in drawings do not have to be physically configured as illustrated in the drawings. In other words, a specific embodiment of the distribution or integration of the individual units is not limited to one of examples illustrated in the drawings, and all or part of the individual units may be configured by being functionally or physically integrated or distributed in arbitrary units according to various loads and various statuses of use. For example, the extraction unit 232 and the determination unit 233 may be integrated with each other.

Furthermore, all or arbitrary part of various kinds of processing functions performed in each of apparatuses may be performed on a CPU (or a microcomputer such as an MPU a micro controller unit (MCU)). It goes without saying that all or arbitrary part of various kinds of processing functions may be performed on a program analyzed and performed in a CPU (or a microcomputer such as an MPU or an MCU) or may be performed on hardware based on wired logic.

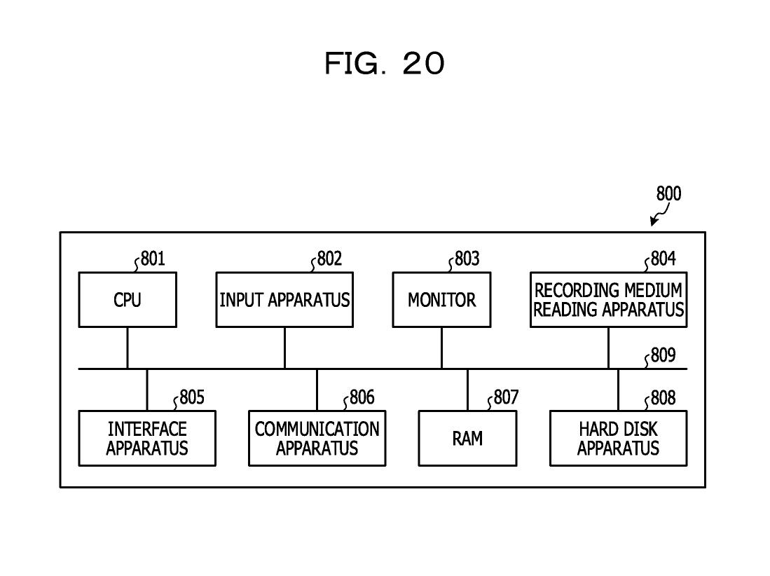

By the way, various kinds of processing described in the above-mentioned examples may be realized by causing a CPU to execute a preliminarily prepared program. Therefore, in what follows, an example of a computer that executes a program having the same functions as those of the above-mentioned examples will be described. FIG. 20 is a diagram illustrating an example of a computer that executes a transmission route design program.

As illustrated in FIG. 20, a computer 800 includes a CPU 801 that performs various kinds of arithmetic processing, an input apparatus 802 that receives data inputs, and a monitor 803. The computer 800 includes a recording medium reading apparatus 804 that reads a program and so forth from a storage medium, an interface apparatus 805 for connecting to various kinds of apparatuses, and a communication apparatus 806 for wirelessly or wiredly connecting to another information processing apparatus or the like. In addition, the computer 800 includes a RAM 807 that temporarily stores therein various kinds of information, and a hard disk apparatus 808. Each of the apparatuses 801 to 808 is connected to a bus 809.

In the hard disk apparatus 808, a transmission route design program that has the same functions as those of the individual processing units of the acquisition unit 231, the extraction unit 232, and the determination unit 233 illustrated in FIG. 1 is stored. In the hard disk apparatus 808, various kinds of data for realizing the intermediate data storage unit 221 and the transmission route design program are stored. The input apparatus 802 receives, from, for example, an administrator of the computer 800, inputting of various kinds of information such as management information. For the administrator of the computer 800, the monitor 803 displays, for example, a screen of the management information and various kinds of screens. For example, a printing apparatus and so forth are connected to the interface apparatus 805. The communication apparatus 806 has the same function as that of, for example, the communication unit 210 illustrated in FIG. 1 and is connected to the network N1, thereby exchanging various kinds of information with the terminal apparatus 10, the network management apparatus 100, and another apparatus.

The CPU 801 reads individual programs stored in the hard disk apparatus 808 and deploys and executes the individual programs in the RAM 807, thereby performing various kinds of processing. These programs are able to cause the computer 800 to function as the acquisition unit 231, the extraction unit 232, and the determination unit 233 illustrated in FIG. 1.

The above-mentioned transmission route design program does not have to be stored in the hard disk apparatus 808. For example, the computer 800 may read a program stored in a storage medium readable by the computer 800 and may execute the program. For example, a portable recording medium such as a CD-ROM, a DVD disk, or a Universal Serial Bus (USB) memory, a semiconductor memory such as a flash memory, a hard disk drive, or the like corresponds to the storage medium readable by the computer 800. The transmission route design program may be stored in apparatuses connected to a public line, the Internet, LAN, and so forth, and the computer 800 may read the transmission route design program from these and may execute the transmission route design program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission route design method executed by a transmission route design system including a transmission route design apparatus configured to determine a route within a network and a network management apparatus configured to manage the network, the transmission route design method comprising:
receiving, by the network management apparatus, new demands respectively including a start time and an end time and respectively used for requesting to set a new route;
acquiring one or more established routes that are already set within the network and that correspond to a time period between an earliest start time and a latest end time, included in the new demands;
dividing the time period into slots, based on the start time and the end time, included in each of the new demands;
generating intermediate data by calculating a maximum traffic load of each of one or more links included in the one or more established routes for each of the slots;
transmitting the generated intermediate data to the transmission route design apparatus;
determining, by the transmission route design apparatus, routes to be allocated to the new demands, based on the generated intermediate data; and
transmitting information of the determined routes to the network management apparatus.

2. The transmission route design method according to claim 1, further comprising
distributing, by the network management apparatus, the information of the determined routes to the network.

3. The transmission route design method according to claim 1,
wherein the dividing includes dividing while using the start time or the end time of each of the new demands as a separator.

4. The transmission route design method according to claim 1, wherein the determining includes:
extracting route candidates from within the network;
generating combination patterns by combining some route candidates from among the route candidates;
extracting one or more route candidates without an excess of a bandwidth from among the route candidates by confirming, by using the route candidates and the intermediate data, whether an excess of a bandwidth occurs in the one or more links for each of the combination patterns; and
determining routes to be allocated to the new demands, from among the one or more extracted route candidates.

5. The transmission route design method according to claim 4,
wherein the determining includes determining so that a load of each of the one or more links does not exceed a bandwidth of each of the one or more links.

6. The transmission route design method according to claim 1,
wherein the determining includes determining so that at least one of a load, power consumption, and a transmission delay that correspond to each of the one or more links is minimized.

7. The transmission route design method according to claim 1, further comprising:
calculating an estimated value of a transmission delay corresponding to each of the one or more links based on a load of each of the one or more links; and
calculating a transmission delay corresponding to each of the new demands by calculating, for each of the new demands, a sum of estimated values of transmission delays of one or more links relating to each of the new demands, and
wherein the determining includes determining routes to be allocated to the new demands based on the calculated transmission delays.

8. The transmission route design method according to claim 1, further comprising:
extracting, by the network management apparatus, one or more yet-to-be-operated routes that are not operated, from among one or more established routes;
generating one or more redesign demands for requesting to reconfigure the one or more yet-to-be-operated routes based on the one or more extracted yet-to-be-operated routes; and
determining, by the transmission route design apparatus, a route to be allocated to each of the one or more redesign demands, based on the generated intermediate data.

9. The transmission route design method according to claim 1,
wherein the determining includes determining routes to be allocated to the new demands by solving a mathematical programming problem, based on the intermediate data.

10. A transmission route design system comprising:
a network management apparatus configured to:
receive new demands respectively including a start time and an end time and respectively used for requesting to set a new route,
acquire one or more established routes that are already set within the network and that correspond to a time period between an earliest start time and a latest end time, included in the new demands,
divide the time period into slots, based on the start time and the end time, included in each of the new demands, and
generate intermediate data by calculating a maximum traffic load of each of one or more links included in the one or more established routes for each of the slots; and
a transmission route design apparatus configured to:
receive the intermediate data from the network management apparatus,
determine routes to be allocated to the new demands, based on the intermediate data, and
transmit information of the determined routes to the network management apparatus.

11. The transmission route design system according to claim 10,
wherein the network management apparatus is configured to divide while using the start time or the end time of each of the new demands as a separator.

12. The transmission route design system according to claim 10, wherein the transmission route design apparatus is configured to:
extract route candidates from within the network;
generate combination patterns by combining some route candidates from among the route candidates;
extract one or more route candidates without an excess of a bandwidth from among the route candidates by confirming, by using the route candidates and the intermediate data, whether an excess of a bandwidth occurs in the one or more links for each of the combination patterns; and
determine routes to be allocated to the new demands, from among the one or more extracted route candidates.

13. The transmission route design system according to claim 12, wherein the transmission route design apparatus is configured to determine so that a load of each of the one or more links does not exceed a bandwidth of each of the one or more links.

14. A transmission route design apparatus coupled to a network management apparatus configured to manage a network and that sets routes within the network, the transmission route design apparatus comprising:
receiving generated intermediate data from the network management apparatus, when the network management apparatus receives new demands respectively including a start time and an end time and respectively used for requesting to set a new route, acquires one or more established routes that are already set within the network and that correspond to a time period between an earliest start time and a latest end time, included in the new demands, divides the time period into slots, based on the start time and the end time, included in each of the new demands, and generates the intermediate data by calculating a maximum traffic load of each of one or more links included in the one or more established routes for each of the slots;
determining routes to be allocated to the new demands, based on the received intermediate data; and
transmitting information of the determined routes to the network management apparatus.
